(19) United States
(12) Patent Application Publication
(10) Pub. No.: US 2010/0215412 A1
(43) Pub. Date: Aug. 26, 2010

(54) TRANSFER APPARATUS, IMAGE FORMING APPARATUS, AND IMAGE FORMING METHOD

(75) Inventors: Satoshi CHIBA, Suwa (JP); Koichi KAMIJO, Matsumoto (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/707,262

(22) Filed: Feb. 17, 2010

(30) Foreign Application Priority Data
Feb. 25, 2009 (JP) 2009-042568

(51) Int. Cl. G03G 15/16

(52) U.S. Cl. 399/310

(57) ABSTRACT

A transfer apparatus includes an image bearing unit, a transfer member and a bias generator. The image bearing unit is configured and arranged to bear an image. The transfer member is arranged with respect to the image bearing unit to form a nip portion therebetween. The transfer member includes a substrate and an elastic member. The substrate has a recessed portion with an opening width of the recessed portion being larger than a width of the nip portion as measured in a moving direction of the transfer member. The elastic member is fixed in the recessed portion and wound around the substrate. The elastic member has a volume resistivity of 1×10⁶ to 1×10¹¹ Ω·cm. The bias generator is configured and arranged to apply a bias electric field to the nip portion.

### CROSS-REFERENCE TO RELATED APPLICATIONS

This application claims priority to Japanese Patent Application No. 2009-042568 filed on Feb. 25, 2009. The entire disclosure of Japanese Patent Application No. 2009-042568 is hereby incorporated herein by reference.

### BACKGROUND

1. Technical Field

The present invention relates to a transfer apparatus, an image forming apparatus, and an image forming method for electro-photography.

2. Related Art

JP-T-2000-508280 discloses an image forming apparatus including a transfer roller of the thermal transfer type with the transfer roller having a layer made of relatively soft material.

### SUMMARY

Unlike the thermal transfer type disclosed in JP-T-2000-508280, the present invention relates to the bias transfer type. An elastic member of a transfer member of the bias transfer type may be provided with an electrical resistance. In the case where the elastic member is used, there is a problem in that deformation due to stress concentration easily occurs. In addition, as a result, there is a problem in that the life cycle thereof is shortened.

Accordingly, an advantage of some aspects of the invention is to provide a transfer apparatus for excellently performing transfer and an image forming apparatus and method for excellently forming an image by reducing deformation of an elastic member of a transfer member and transfer defect involved with the deformation. Another advantage of some aspects of the invention is to increase a life cycle of an elastic member in a transfer apparatus and image forming apparatus.

According to one aspect of the invention, a transfer apparatus includes an image bearing unit, a transfer member and a bias generator. The image bearing unit is configured and arranged to bear an image. The transfer member is arranged with respect to the image bearing unit to form a nip portion therebetween. The transfer member includes a substrate and an elastic member. The substrate has a recessed portion with an opening width of the recessed portion being larger than a width of the nip portion as measured in a moving direction of the transfer member. The elastic member is fixed in the recessed portion and wound around the substrate. The elastic member has a volume resistivity of 1×10⁶ to 1×10¹¹ Ω·cm. The bias generator is configured and arranged to apply a bias electric field to the nip portion.

In addition, the elastic member may contain resistance adjusting particles.

In addition, the elastic member may include a first layer disposed on the substrate and a second layer disposed on the first layer with the second layer having elasticity.

In addition, the elastic member may include a third layer disposed on the second layer with the third layer having a friction coefficient that is smaller than that of the second layer.

According to another aspect of the invention, an image forming apparatus includes a latent image bearing part, a developing unit, a transfer medium, a transfer member, and a bias generator. The latent image bearing part is configured and arranged to bear a latent image. The developing unit is configured and arranged to develop the latent image on the latent image bearing part by using a liquid developing agent. The transfer medium is a member to which a developed image on the latent image bearing part is transferred. The transfer member is arranged with respect to the transfer medium to form a nip portion therebetween. The transfer member includes a substrate and an elastic member. The substrate has a recessed portion with an opening width of the recessed portion being larger than a width of the nip portion as measured in a moving direction of the transfer medium. The elastic member is fixed in the recessed portion and wound around the substrate with the elastic member having a volume resistivity of 1×10⁶ to 1×10¹¹ Ω·cm. The bias generator is configured and arranged to apply a bias electric field to the nip portion.

In addition, the elastic member may include a first layer disposed on the substrate and a second layer disposed on the first layer with the second layer having elasticity.

In addition, the elastic member may include a third layer disposed on the second layer with the third layer having a friction coefficient that is smaller than that of the second layer.

In addition, the elastic member may contain resistance adjusting particles.

In addition, the transfer medium may include an elastic layer.

In addition, the transfer member may be configured and arranged to rotate such that a rotating period of the transfer member and a moving period of the transfer medium have a non-integer multiple relationship.

In addition, the rotating period of the elastic member may be shorter than the moving period of the transfer medium.

In addition, the substrate of the transfer member may include a transfer material gripping portion disposed in the recessed portion, the transfer material gripping portion being configured and arranged to grip a transfer material.

In addition, the substrate of the transfer member may include a transfer material detaching portion disposed in the recessed portion, the transfer material detaching portion being configured and arranged to detach the transfer material from the transfer member.

In the transfer apparatus and the image forming apparatus according to the above aspects, since the transfer member may be formed in the state of having no nip portion with respect to the elastic member that is fixed in the recessed portion and wound around the outer circumference of the substrate, the deformation of the elastic member of the transfer roller and the transfer defect involved with the deformation are reduced. Accordingly, it is possible to provide a transfer apparatus for excellently performing transfer and an image forming apparatus for excellently forming an image.

In addition, in the case where resistance adjusting particles of adjusting a transfer bias so as to excellently perform transfer are contained in the elastic member, in general, small deformation unevenness may easily occur. However, in the transfer apparatus and the image forming apparatus according to the above aspects, since a state where the nip portion with respect to the elastic member is not formed may be formed, the small deformation unevenness in the elastic member caused by the resistance adjusting particles may be reduced.

In addition, in the case where the elastic member includes the first layer and the second layer, the nip width or the tension may be adjusted by adjusting the degree of elasticity or the thickness, but the deformation may easily occur. However, in the transfer apparatus and the image forming apparatus according to the invention, since a state where the nip portion with respect to the elastic member is not formed may be formed, the deformation occurring in the elastic member may be reduced. In addition, since the elastic member includes a third layer having a friction coefficient that is smaller than that of the second layer, the frictional resistance may be reduced, so that the deformation occurring in the elastic member may be reduced.

In addition, when the transfer medium has an elastic layer, no nip portion may be formed when the recessed portion of the transfer member is positioned at the nip portion with respect to the transfer medium. In this configuration, the deformation of the elastic layer of the transfer medium and the transfer defect involved with the deformation are reduced. Accordingly, it is possible to provide a transfer apparatus for excellently performing transfer and an image forming apparatus for excellently forming an image.

In addition, when the rotating period of the transfer member and the moving period of the transfer medium are set to have a non-integer multiple relationship, the relaxation in pressure at the same position of the transfer medium is prevented and the accumulation of deformation at the same position is prevented.

In addition, since the rotating period of the elastic member is smaller than the moving period of the transfer medium, the deformation in the rotation axial direction of the transfer medium may be removed.

In addition, when the transfer member has the transfer material gripping portion that grips the transfer material, a variation in position of the transfer material with respect to the transfer member may be reduced.

In addition, when the transfer member has the transfer material detaching portion that detaches the transfer material, the detachment of the transfer material from the transfer member may be excellently performed.

### BRIEF DESCRIPTION OF THE DRAWINGS

Referring now to the attached drawings which form a part of this original disclosure:

FIG. 1 is a view illustrating an image forming apparatus according to a first embodiment.

FIG. 2 is a view illustrating an image forming apparatus according to a second embodiment.

FIG. 3 is a view illustrating a secondary transfer roller of the image forming apparatus according to the first and second embodiments.

FIG. 4 is a partially enlarged view of FIG. 3.

FIG. 5 is a view illustrating a state where a transfer material is not supplied to the secondary transfer roller of the image forming apparatus according to the first embodiment.

FIG. 6 is a view illustrating a state where a gripper of the secondary transfer roller is to grip the transfer material according to the first embodiment.

FIG. 7 is a view illustrating a state where the gripper of the secondary transfer roller grips the transfer material according to the first embodiment.

FIG. 8 is a view illustrating a state where the gripper of the secondary transfer roller is separated and an extruding claw is extruding the transfer material according to the first embodiment.

FIG. 9 is a view illustrating an operation of a transfer material transport unit used for the image forming apparatus according to the first embodiment.

FIG. 10 is a view illustrating operations of the transfer material transport unit used for the image forming apparatus according to the first embodiment.

FIG. 11 is a view illustrating a rotational axis and a substrate of the secondary transfer roller of the image forming apparatus according to the first and second embodiments.

FIG. 12 is a view illustrating a rubber sheet as an elastic member of the secondary transfer roller according to the first and second embodiments.

FIG. 13 is a cross-sectional view illustrating a configuration of winding the secondary transfer roller with the rubber sheet according to the first and second embodiments.

FIG. 14 is a view illustrating a structure of applying a bias to the rotational axis and the substrate of the secondary transfer roller according to the first and second embodiments.

FIG. 15 is a view illustrating an opening width of a recessed portion of the secondary transfer roller according to the first and second embodiments.

FIG. 16 is a view illustrating a nip width of a nip portion between a secondary transfer roller and a belt driving roller according to the first embodiment.

FIG. 17 is a schematic view for explaining calculation of the nip width of the nip portion between the secondary transfer roller and the belt driving roller according to the first embodiment.

FIG. 18 is a view illustrating a state where the belt driving roller according to the first embodiment is located at a position corresponding to a recessed portion of the secondary transfer roller.

FIG. 19 is a view illustrating a nip width of a nip portion between a secondary transfer roller and a belt driving roller according to the second embodiment.

FIG. 20 is a schematic view for explaining calculation of the nip width of the nip portion between the secondary transfer roller and the belt driving roller according to the second embodiment.

FIG. 21 is a schematic view for obtaining an angle θ1 used for the calculation according to the second embodiment.

FIG. 22 is a view illustrating a state where the belt driving roller according to the second embodiment is located at a position corresponding to a recessed portion of the secondary transfer roller.

FIGS. 23A to 23C are cross-sectional views illustrating a relationship among a secondary transfer roller, belt driving roller, an intermediate transfer belt, and an abutting member according to the first and second embodiments.

FIG. 24 is a view illustrating a modified example of the abutting member.

FIG. 25 is a view illustrating an image forming apparatus according to a third embodiment.

FIG. 26 is a view illustrating a nip width of a nip portion between a transfer roller and an intermediate transfer drum according to the third embodiment.

FIG. 27 is a schematic view for explaining calculation of the nip width of the secondary transfer roller and the transfer drum according to the third embodiment.

FIG. 28 is a view illustrating a state where the transfer drum according to the third embodiment is located at a position corresponding to a recessed portion of the secondary transfer roller.

### DESCRIPTION OF EXEMPLARY EMBODIMENTS

Hereinafter, exemplary embodiments of the invention will be described with reference to the accompanying drawings.

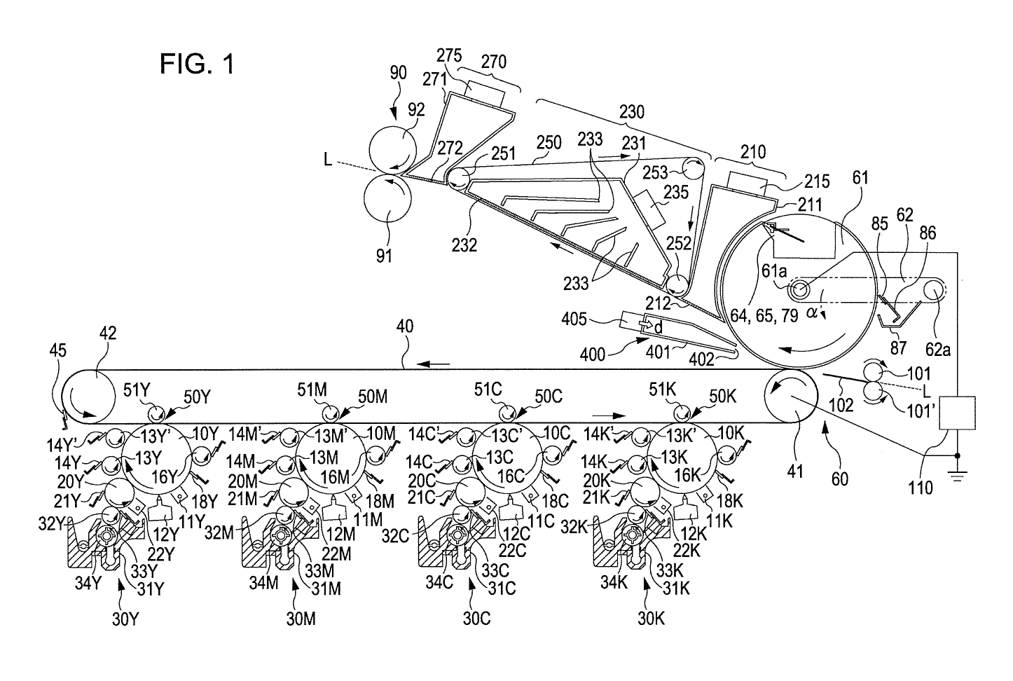

FIG. 1 is a view illustrating main components constituting an image forming apparatus according to a first embodiment. With reference to an intermediate transfer belt 40 as a transfer medium (also forming a part of the image bearing unit) disposed in the central portion of the image forming apparatus, developing units 30Y, 30M, 30C, and 30K as developing units are disposed in the lower portion of the image forming apparatus, and a configuration of a secondary transfer unit 60 as a transfer unit, a fixing unit 90, and the like is disposed in the upper portion of the image forming apparatus. Particularly, the fixing unit 90 is disposed above the intermediate transfer belt 40, so the entire installation area of the image forming apparatus may be suppressed.

In order to form an image with a toner, around the photoreceptors 10Y, 10M, 10C, and 10K as latent image bearing parts (also forming a part of the image bearing unit), corona chargers 11Y, 11M, 11C, and 11K, exposing units 12Y, 12M, 12C, and 12K such as LED arrays, and the like are disposed. The photoreceptors 10Y, 10M, 10C, and 10K are uniformly charged by the corona chargers 11Y, 11M, 11C, and 11K, and an exposure process is performed based on an input image signal by the exposing units 12Y, 12M, 12C, and 12K, so that electrostatic latent images are formed on the charged photoreceptors 10Y, 10M, 10C, and 10K.

The developing units 30Y, 30M, 30C, and 30K mainly include: developing rollers 20Y, 20M, 20C, and 20K as developing agent containers; developing agent reservoirs 31Y, 31M, 31C, and 31K, which store liquid developing agents for colors of yellow (Y), magenta (M), cyan (C), and black (K); and anilox rollers 32Y, 32M, 32C, and 32K as developing agent supplying members that are coating rollers for coating the developing rollers 20Y, 20M, 20C, and 20K with the liquid developing agents for the colors from the developing agent reservoirs 31Y, 31M, 31C, and 31K. The developing units 30Y, 30M, 30C, and 30K develop the electrostatic latent images on the photoreceptors 10Y, 10M, 10C, and 10K by using the liquid developing agents for the colors.

Primary transfer units 50Y, 50M, 50C, and 50K transfer the images formed on the photoreceptors 10Y, 10M, 10C, and 10K to the intermediate transfer belt 40 through nip portions between the photoreceptors 10Y, 10M, 10C, and 10K and the primary transfer rollers 51Y, 51M, 51C, and 51K.

The intermediate transfer belt 40 is constructed with an elastic member such as a seamless rubber. The intermediate transfer belt 40 is suspended by a belt driving roller 41 and a tension roller 42. The intermediate transfer belt 40 is rotated by the belt driving roller 41 while abutting on the primary transfer units 50Y, 50M, 50C, and 50K and the photoreceptors 10Y, 10M, 10C, and 10K. In the primary transfer units 50Y, 50M, 50C, and 50K, the primary transfer rollers 51Y, 51M, 51C, and 51K are disposed to face the photoreceptors 10Y, 10M, 10C, and 10K with the intermediate transfer belt 40 interposed therebetween, and at the abutting positions with respect to the photoreceptors 10Y, 10M, 10C, and 10K as the transferring positions, the toner images of the colors developed on the photoreceptors 10Y, 10M, 10C, and 10K are transferred to the intermediate transfer belt 40 in a sequentially overlapped manner, so that a full colored toner image is formed.

The secondary transfer unit 60 includes the secondary transfer roller 61 as a transfer member and a secondary transfer roller cleaning blade 85. A rotational axis 61a of the secondary transfer roller 61 is rotatably supported by an arm 62. The arm 62 is swingly rotated around a rotational axis 62a that is supported by an apparatus main body (not shown) and is forced by a spring (not shown) in a direction a (counterclockwise in FIG. 1) indicated by the arrow. Due to the force of the spring, the secondary transfer roller 61 is pressed on the belt driving roller 41 through the intermediate transfer belt 40. Therefore, the secondary transfer roller 61 is rotated in the direction indicated by the arrow according to the rotation of the belt driving roller 41 and applied with a transfer bias by a bias generator 110, so that the toner image of the intermediate transfer belt 40 is transferred through the transferring nip to a transfer material S such as paper, films, or cloths, which is transported along a transfer material transport path L. In addition, the secondary transfer unit 60 includes a transfer roller cleaning blade 85 that cleans the secondary transfer roller 61.

In the transfer material transport path L, at the downstream of the secondary transfer unit 60, a first suction unit 210, a transfer material transport unit 230, and a second suction unit 270 are sequentially disposed, so that the transfer material S is transported to the fixing unit 90. In the fixing unit 90, a monochromic toner image or a full colored toner image transferred on the transfer material S such as paper is fused and fixed on the transfer material S such as paper.

The transfer material S is supplied to the image forming apparatus by a feeding unit (not shown). The transfer material S set in the feeding unit is extruded sheet by sheet to the transfer material transport path L at a predetermined timing. In the transfer material transport path L, the transfer material S is transported to the secondary transfer position by gate rollers 101 and 101′ and a transfer material guide 102, so that the monochromic developed toner image or the full colored developed toner image formed on the intermediate transfer belt 40 is transferred to the transfer material S.

The transfer material S that is subjected to the secondary transfer process is further transported to the fixing unit 90 by the transfer material transport unit where the transfer material transport unit 230 is located at the central portion thereof as described above. The fixing unit 90 includes a heating roller 91 and a pressing roller 92 that is forced to the heating roller 91 by a predetermined pressure. The fixing unit 90 inserts the transfer material S between the nips to fuse and fix the monochromic toner image or the full color toner image, which is transferred to the transfer material S, on the transfer material S such paper.

Herein, the developing units are described. Since the configurations of the peripherals of the photoreceptors and the developing units of the colors are the same, the peripherals of the photoreceptor and the developing unit of the yellow (Y) are representatively described in the description hereinafter.

In the peripherals of the photoreceptor, an exposing unit 12Y, a developing roller 20Y of a developing unit 30Y, a first photoreceptor squeeze roller 13Y, a second photoreceptor squeeze roller 13Y′, a primary transfer unit 50Y, a neutralizing unit (not shown), and a photoreceptor cleaning blade 18Y are disposed in the rotation direction of the outer circumference of the photoreceptor 10Y from a corona charger 11Y as a reference. In addition, with respect to the image forming process, in the order from the corona charger 11Y to the photoreceptor cleaning blade 18Y, a configuration disposed at the front end is defined to be at the upstream from a configuration disposed at the rear end.

The photoreceptor 10Y is a photoreceptor drum constructed with a cylindrical member, of which the outer surface is proved with a photoreception layer such as an amorphous silicon photoreceptor. In FIG. 1, the photoreceptor 10Y is rotated clockwise.

The corona charger 11Y is disposed at the upstream side in the rotational direction of the photoreceptor 10Y from the nip portion between the photoreceptor 10Y and the developing roller 20Y. The corona charger 11Y is applied with a voltage by a power supply unit (not shown) to corona-charge the photoreceptor 10Y. The exposing unit 12Y is disposed at the downstream in the rotational direction of the photoreceptor 10Y from the corona charger 11Y and at the upstream from the nip portion between the developing roller 20Y and the photoreceptor 10Y. The exposing unit 12Y illuminates the photoreceptor 10Y charged by the corona charger 11Y with light to form a latent image on the photoreceptor 10Y.

In addition, the developing unit 30Y includes a developing roller 20Y where the aforementioned liquid developing agent is contained, an anilox roller 32Y that is a coating roller for coating the developing roller 20Y with the liquid developing agent, a regulating blade 33Y that regulates a liquid developing agent amount coated on the developing roller 20Y, an auger 34Y that stirs and transports the liquid developing agent and supplies the liquid developing agent to the anilox roller 32Y, a compaction corona generator 22Y that allows the liquid developing agent contained in the developing roller 20Y to be in a compaction state, a developing roller cleaning blade 21Y that cleans the developing roller 20Y, and a developing agent reservoir 31Y that stores the liquid developing agent in the state where the toner in a carrier is dispersed at about 20 wt %.

The liquid developing agent stored in the developing agent reservoir 31Y is not a volatile liquid developing agent, where ISOPA (trade mark: Exxon Co.) generally used in the related art is used as a carrier and which has a low concentration (about 1 to 3 wt %), a low viscosity, and volatility at a normal temperature, but a non-volatile liquid developing agent which has a high concentration, a high viscosity, and non-volatility at the normal temperature. In other words, the liquid developing agent according to the embodiments is obtained by adding solid particles having an average particle diameter of 1 μm, where a colorant such as a pigment is dispersed in a thermoplastic resin, together with a dispersing agent to a liquid solvent such as an organic solvent, a silicon oil, a mineral oil, or an edible oil. The liquid developing agent has a concentration of the toner solid constituents as a range of about 15 to 25% and a high viscosity (a viscous elasticity of about 30 to 300 mPa·s measured by using HAAKE RHEOSTRESS RS600 at 25° C. at a shearing speed of 1000(1/s)).

In addition, the disposing order of the members such as the photoreceptors or the developing units corresponding to the colors Y, M, C, and K is not limited to the aforementioned example shown in FIG. 1, but it may be set arbitrarily.

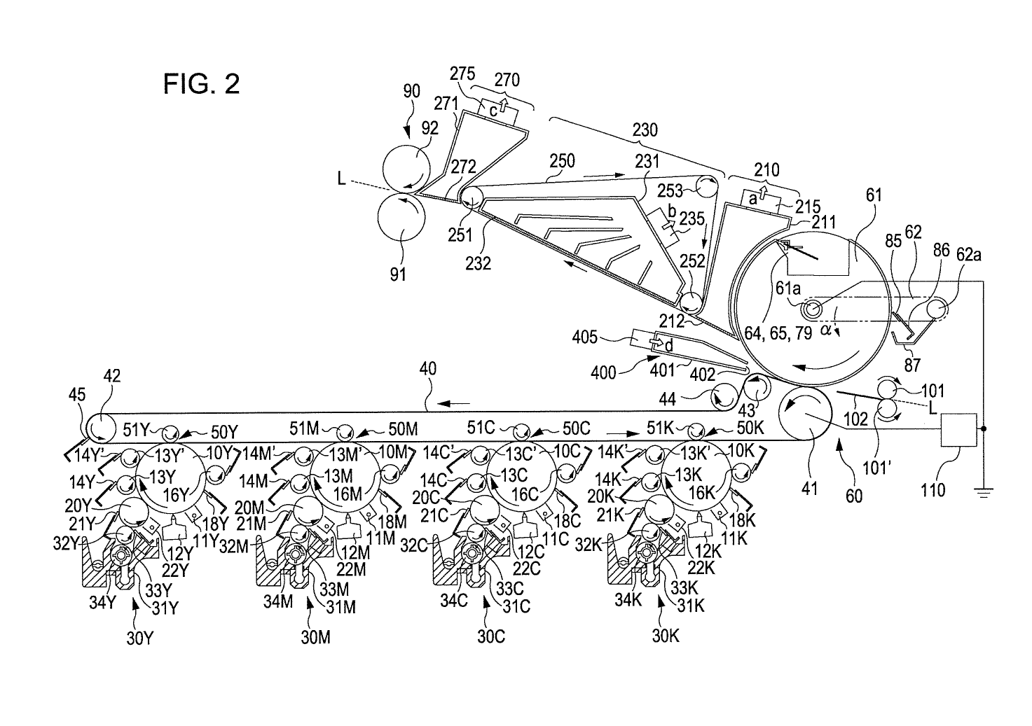

FIG. 2 is a view illustrating main components constituting an image forming apparatus according to a second embodiment. In the image forming apparatus according to the second embodiment, the nip portion between the belt driving roller 41 and secondary transfer roller 61 in the image forming apparatus according to the first embodiment is changed into a winding manner.

The intermediate transfer belt 40 according to the second embodiment is suspended by a belt driving roller 41, a first tension roller 42, a second tension roller 43, and a third tension roller 44. The intermediate transfer belt 40 is rotated by the belt driving roller 41 while abutting on the primary transfer units 50Y, 50M, 50C, and 50K and the photoreceptors 10Y, 10M, 10C, and 10K. In the primary transfer units 50Y, 50M, 50C, and 50K, the primary transfer rollers 51Y, 51M, 51C, and 51K are disposed to face the photoreceptors 10Y, 10M, 10C, and 10K with the intermediate transfer belt 40 interposed therebetween, and at the abutting positions with respect to the photoreceptors 10Y, 10M, 10C, and 10K as the transferring positions, the toner images of the colors developed on the photoreceptors 10Y, 10M, 10C, and 10K are transferred to the intermediate transfer belt 40 in a sequentially overlapped manner, so that a full colored toner image is formed.

The secondary transfer unit 60 includes a secondary transfer roller 61 that is disposed to face the belt driving roller 41 with the intermediate transfer belt 40 interposed therebetween and a cleaning unit that is constructed with a secondary transfer roller cleaning blade 85. Therefore, at a transferring position where the secondary transfer roller 61 is located, a monochromic toner image or a full-colored toner image formed on the intermediate transfer belt 40 is transferred to a transfer material such as paper, film, or cloth, which is transported along a transfer material transport path L.

The first tension roller 42 together with the belt driving roller 41 that suspends the intermediate transfer belt 40. At the position of the intermediate transfer belt 40 that is suspended by the first tension roller 42, the cleaning unit that is constructed with the transfer belt cleaning blade 45 is disposed to abut, so that the remaining toner and carriers on the intermediate transfer belt 40 are cleaned.

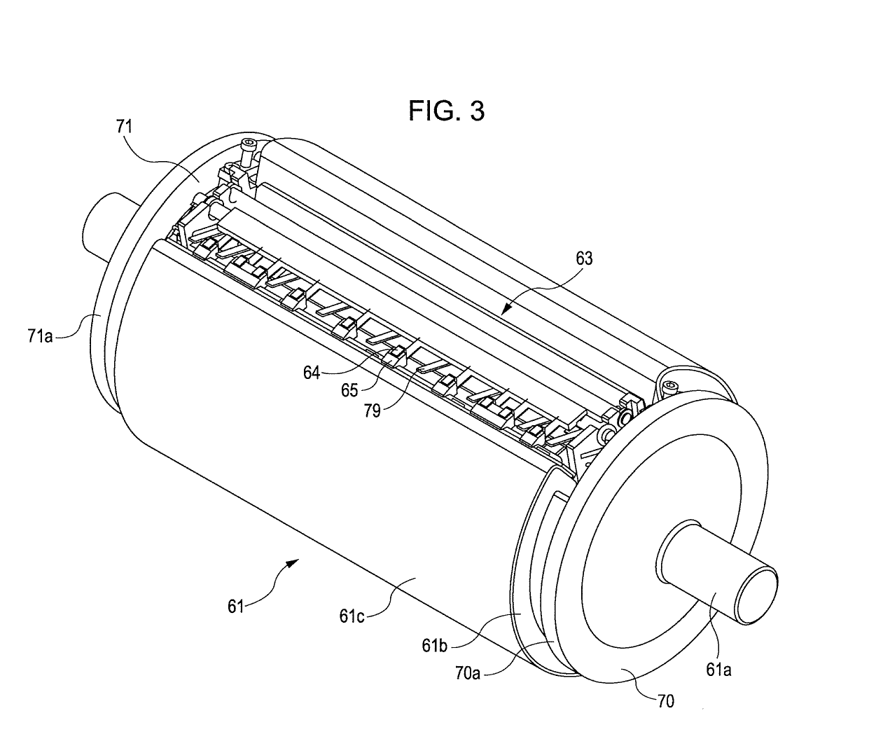

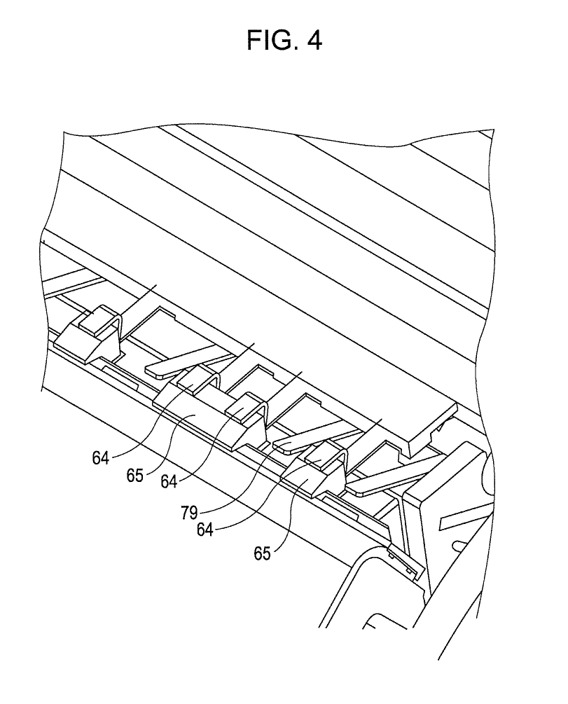

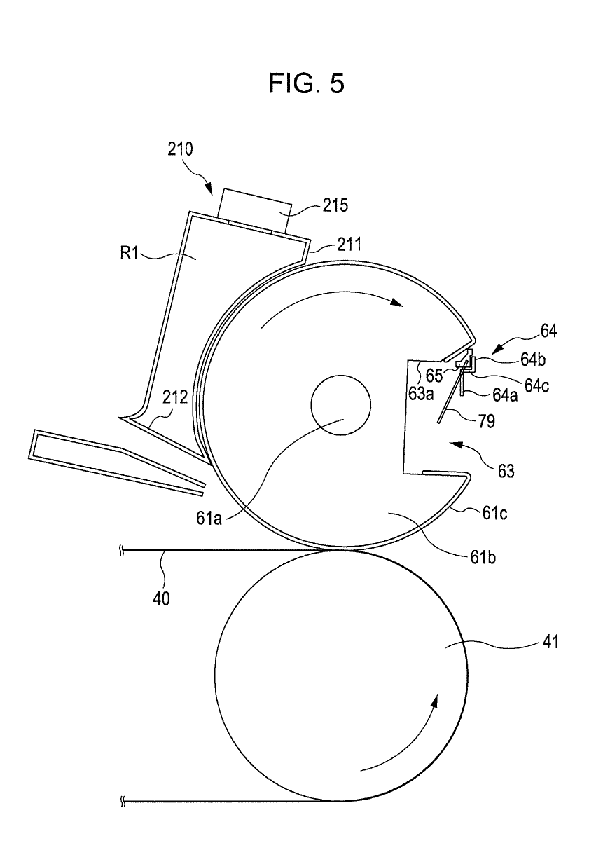

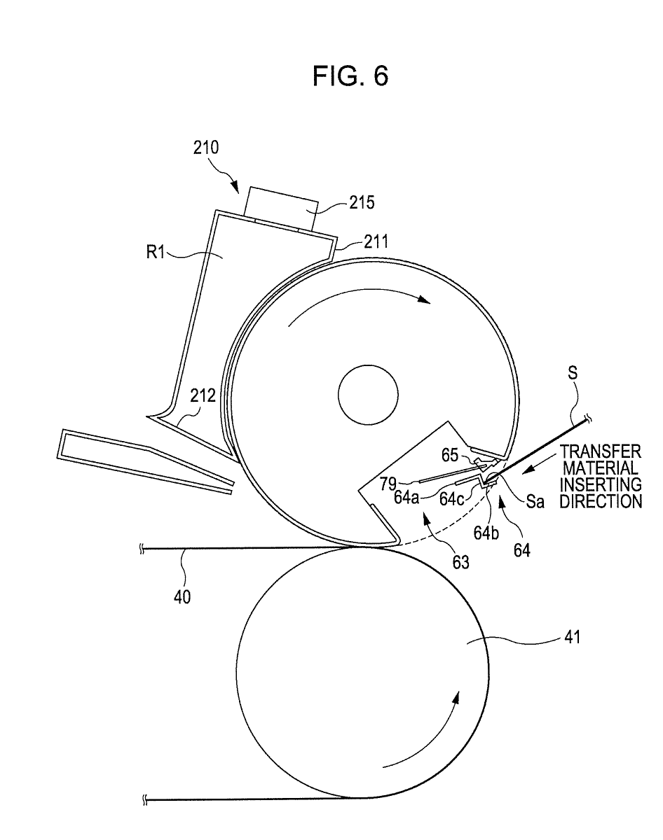

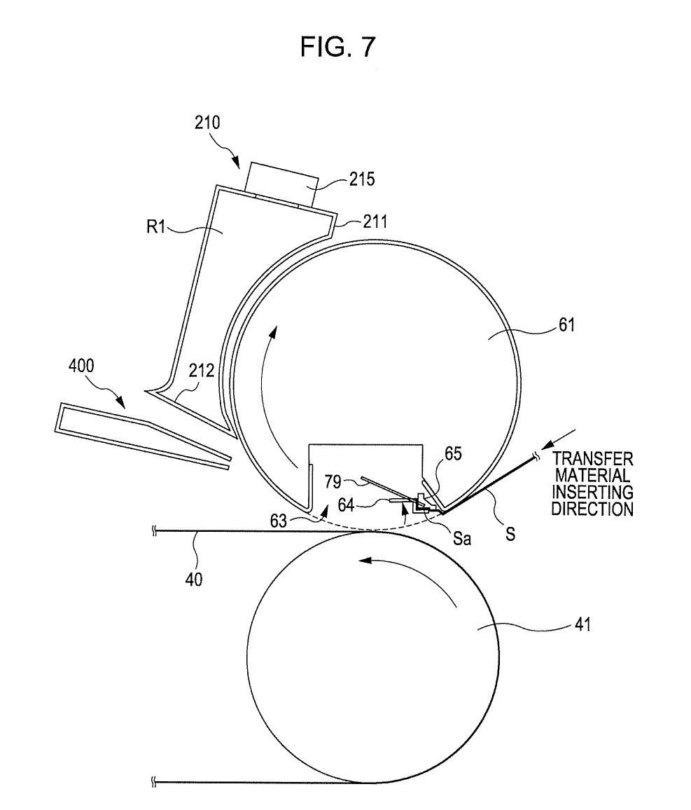

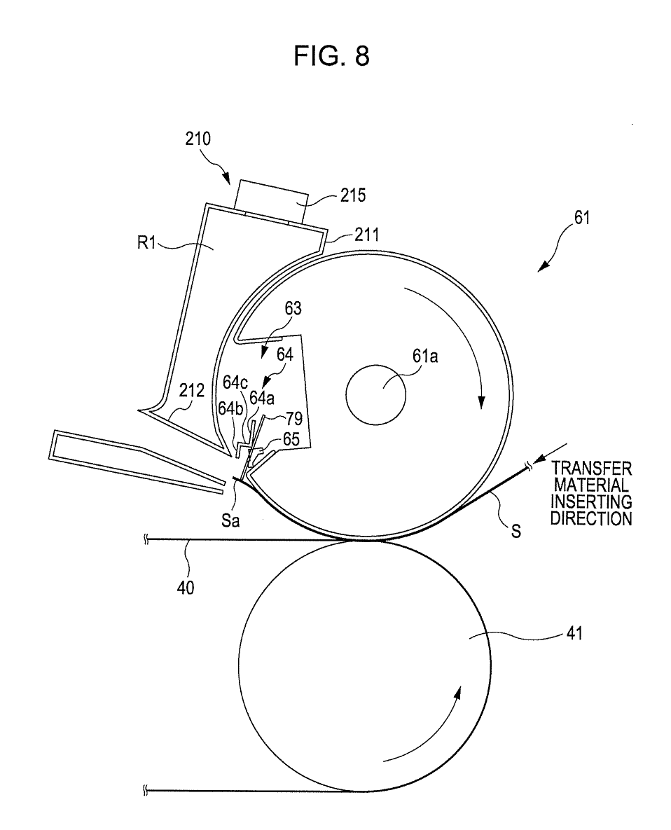

Next, the configuration of the secondary transfer roller 61 is described. FIG. 3 is a view illustrating the secondary transfer roller 61, and FIG. 4 is a partially enlarged view of the secondary transfer roller 61. In addition, FIGS. 5 to 8 illustrate a series of processes from a process before the transfer material S is gripped in the secondary transfer roller 61 to a process where the transfer material S is extruded. FIG. 5 is a view illustrating a state where the transfer material S is not gripped in secondary transfer roller 61. FIG. 6 is a view illustrating a state where a gripper 64 of the secondary transfer roller 61 is to grip the transfer material S. FIG. 7 is a view illustrating a state where the gripper 64 of the secondary transfer roller 61 grips the transfer material S. FIG. 8 is a view illustrating a state where the gripper 64 of the secondary transfer roller 61 is separated and an extruding claw 79 (a transfer material detaching portion) extrudes the transfer material S.

The secondary transfer roller 61 has a recessed portion 63 as a recessed portion or a transfer material gripping member receiver. As shown in FIG. 3, the recessed portion 63 is disposed to extend in the axial direction of the secondary transfer roller 61. In addition, the secondary transfer roller 61 has a rubber sheet 61c as an elastic member that is wound around an outer circumferential surface of a circular arc portion of a substrate 61b. A resistive layer is formed on the outer circumferential surface of the circular arc portion of the secondary transfer roller 61 by the rubber sheet 61c.

In addition, in the recessed portion 63, the gripper 64 as a transfer material gripping portion according to the embodiments and a gripper supporting portion 65 as a transfer material gripping portion supporter where the gripper 64 is mounted are disposed. As shown in FIGS. 3 and 4, an arbitrary number of the grippers 64 are disposed in the axial direction of the secondary transfer roller 61.

Each gripper 64 is constructed with a thin-stripped metal plate. The grippers 64 are foamed in the same shape and/or size. As an example, each gripper 64 is formed to be bent in a crank shape. As shown in FIG. 5, the one end portion of the gripper 64 is a fixing end portion 64a that is fixed to the rotational axis, and the other end portion of the gripper 64 is a gripping portion 64b that is to be mounted on and separated from the gripper supporting portion 65. The gripping portion 64b grips the transfer material S by pressing the front end portion Sa of the transfer material S between the gripper supporting portion 65 and the gripping portion 64b. In addition, the gripper 64 has an end portion 64c formed between the fixing end portion 64a and the gripping portion 64b.

The circumferential length of the secondary transfer roller 61 is set to be longer than the transfer material moving direction length of the transfer material S having the maximum transfer material moving direction length among types of the transfer materials S used in the image forming apparatus according to the embodiment. More specifically, the circumferential length of the secondary transfer roller 61, in which the secondary transfer roller rotational direction width of the recessed portion 63 is excluded, is set to be longer than the aforementioned maximum transfer material moving direction length of the transfer material S. Accordingly, the toner image of the intermediate transfer belt 40 is securely transferred to the aforementioned maximum transfer material moving direction length of the transfer material S.

In addition, as shown in FIG. 3, the secondary transfer roller 61 is provided with abutting members 70 and 71 which are integrally rotated. The abutting members 70 and 71 have outer circumferential surfaces 70a and 71a having a circular arc shape that is concentric with the secondary transfer roller 61. The abutting members 70 and 71 directly or indirectly abut on the belt driving roller 41 when the recessed portion 63 of the secondary transfer roller 61 faces the position of the pressing nip with respect to the belt driving roller 41.

As shown in FIG. 3, the gripper supporting portions 65, of which the number corresponds to the number of the grippers 64 are disposed in the axial direction of the secondary transfer roller 61. As shown in FIG. 5, the gripper supporting portions 65 are disposed at the side wall 63a of the recessed portion 63 that is at the rear side of the recessed portion 63 in the rotational direction of the secondary transfer roller 61.

In addition, extruding claws 79 are disposed in the recessed portion 63. As shown in FIGS. 3 and 4, the extruding claws 79 are disposed in the axial direction of the secondary transfer roller 61. An arbitrary number of the extruding claws 79 may be disposed. In addition, the gripper supporting portions 65 are disposed to be located between the adjacent extruding claws 79. Each extruding claw 79 is constructed with a thin-stripped metal plate. The extruding claws 79 are formed in the same shape and/or size. Although not shown, the extruding claws 79 are integrally connected at a connection portion to constitute a pectinate shape.

Next, an image forming operation is described.

Similarly to the image forming apparatus in the related art where the liquid developing agents are used and the photoreceptors of the colors are disposed, when the image forming operation starts, the photoreceptors 10Y, 10M, 10C, and 10K are uniformly charged by the corona chargers 11Y, 11M, 11C, and 11K. Next, the exposing units 12Y, 12M, 12C, and 12K write electrostatic latent images on the photoreceptors 10Y, 10M, 10C, and 10K (first to fourth writing process). Next, the electrostatic latent images on the photoreceptors 10Y, 10M, 10C, and 10K are developed with the liquid developing agents by the developing units 30Y, 30M, 30C, and 30K, so that the toner images are formed (first to fourth developing processes).

The toner images of the photoreceptors 10Y, 10M, 10C, and 10K are transferred to the intermediate transfer belt 40 by the primary transfer units 50Y, 50M, 50C, and 50K (first transferring process). The toner images contained in the intermediate transfer belt 40 are transferred to the transported transfer material S by the secondary transfer unit 60.

The transfer of the toner images to the transfer material S in the secondary transfer unit 60 is described more in detail.

If the intermediate transfer belt 40 starts rotating due to the rotation of the belt driving roller 41, the transfer roller 61 also rotated. At this time, as shown in FIG. 5, the gripping portion 64b of the gripper 64 is mounted on the gripper supporting portion 65. In addition, the extruding claw 79 is set to the receding position.

As each of the toner images contained in the intermediate transfer belt 40 approaches the secondary transfer unit 60, each of the grippers 64 is separated from the gripper supporting portion 65.

As shown in FIG. 6, the gripper 64 that is set to the releasing position approaches the transfer material S applying position by the rotation of the transfer roller 61. On the other hand, the transfer material S is supplied to the transfer roller 61, and the toner image contained the intermediate transfer belt 40 approaches the secondary transfer unit 60. The rotation of the belt driving roller 41 and the rotation of the transfer roller 61 are controlled to be synchronized so that the toner images of the intermediate transfer belt 40 are transferred to predetermined positions of the transfer material S through the transferring nip portion. At this time, the circumferential speed of the transfer roller 61 (that is, the moving speed of the gripper 64) is set to be lower than the moving speed of the transfer material S. Therefore, the front end of the transfer material S is inserted between the gripper 64 and the gripper supporting portion 65 so as to abut on the end portion 64c of the gripper 64. Accordingly, due to a speed difference between the circumferential speed of the transfer roller 61 and the moving speed of the transfer material S, the front end of the transfer material S abuts on the corner portion of the end portion 64c to be positioned with respect to the gripper 64, and the front end portion Sa of the transfer material S is bent.

Subsequently, a portion of the transfer material S abuts on the outer circumferential surface of the transfer roller 61 and is bent along the outer circumferential surface. Each gripper 64 starts approaching the gripper supporting portion 65. Next, as shown in FIG. 7, each gripper 64 is in the state where the gripper 64 grips the transfer material S by pressing the front end portion Sa of the transfer material S on the gripper supporting portion 65. Therefore, the transfer material S is positioned with respect to the transfer roller 61, and the transfer material S is accurately moved toward the transferring nip according to the rotation of the transfer roller 61. At this time, the extruding claw 79 is maintained at the receding position.

The toner image of the intermediate transfer belt 40 is transferred to the transfer material S by the transferring nip. If the gripping portion 64a of the gripper 64 and the front end portion Sa of the transfer material S pass through the transferring nip, as shown in FIG. 8, the gripper 64 starts moving in the direction where the gripper 64 is separated from a clawing seat 65, so that the front end portion Sa of the transfer material S is released. Next, the transfer roller 61 is further rotated so that the extruding claw 79 is set to the extruding position.

On the other hand, the front end portion Sa of the transfer material S released from the gripping of the gripper 64 is weakly pressed toward the side of the transfer roller 61 by air sprayed from a blowing unit 400 described later, and at the same time, pressed in the direction of separating from the outer circumferential surface 61g of the transfer roller 61 by the extruding claw 79. Accordingly, the front end portion Sa of the transfer material S is introduced to the transfer material transport unit. The transfer material S that is pressed through the nip portion between the belt driving roller 41 and the transfer roller 61 is moved to the transfer material transport unit by the rotation of the belt driving roller 41 and the rotation of the transfer roller 61. In other words, the toner image of the intermediate transfer belt 40 is secondarily transferred to the transfer material S, and the detachment of the transfer-completed portion of the transfer material S is performed (transferring and detaching processes). In addition, in the case of a transfer material S having a small elastic restoring force and a weak bending portion, the air spraying from the blowing unit 400 may be omitted.

Next, the transfer material transport unit according to the embodiments is described.

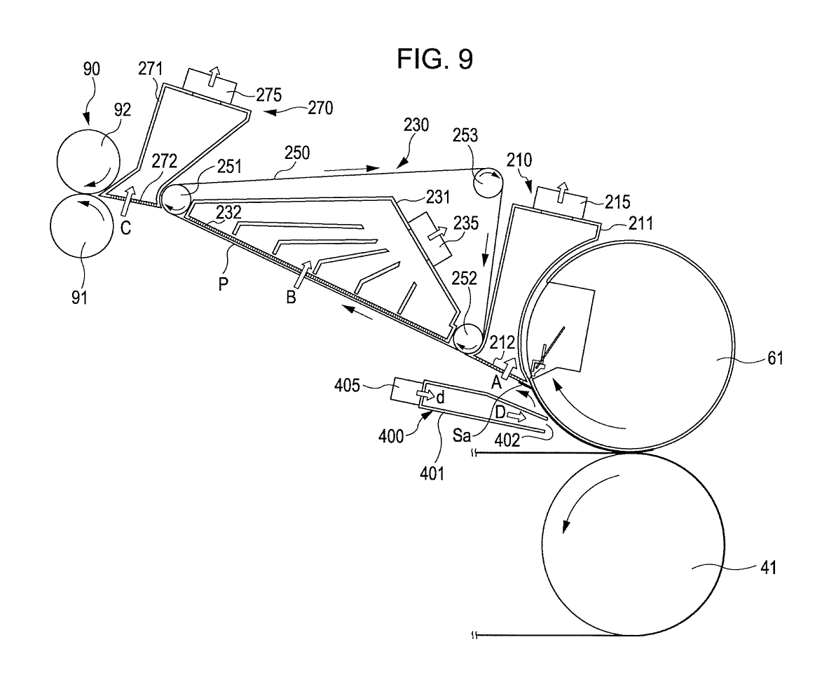

FIG. 9 illustrates a state where the transport direction front end portion Sa of the transfer material S is extruded from the secondary transfer nip of the secondary transfer unit 20, that is, a state just after the transfer material S is guided from the side of the secondary transfer unit 20 toward the transport unit. As shown in the figure, the transfer material S is supported on a suction surface 212 without dropping by a suction force A from the suction surface 212 of the housing portion 211 generated in involvement with an operation of an airflow generator 215 of the first suction unit 210, and the transfer material S is transported on the suction surface 212 by a force of a transporting operation from the side of the secondary transfer unit 60.

The transport direction front end portion Sa of the transfer material S that is transported on the suction surface 212 of the first suction unit 210 by receiving the force of the transporting operation of the side of the secondary transfer unit 60 approaches the side of the transfer material transport unit 230. Next, the transfer material S is supported on a transporting surface P by a suction force B from the suction surface 232 of the housing 231 generated in involvement with an operation of the airflow generator 235 of the transfer material transport unit 230. In addition, the transfer material S is transported along the transporting surface P toward the fixing unit 90 by a driving force of a transfer material transport member driving roller 251 in involvement with the moving operation of the transfer material transport member 250 that winds the transfer material transport member driving roller 251 and transfer material transport member suspending rollers 252 and 253.

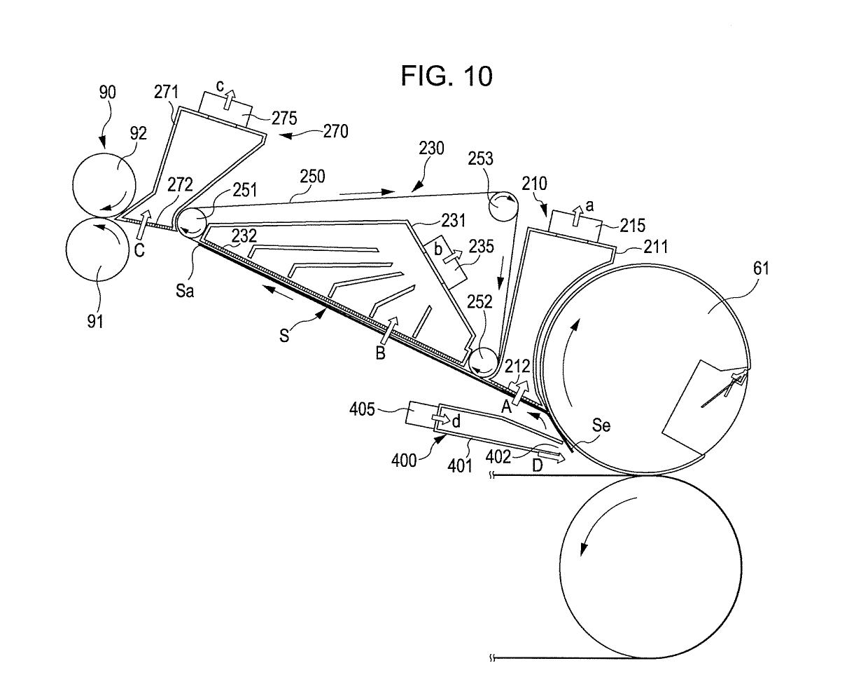

FIG. 10 illustrates a state just after the transport direction rear end portion Se of the transfer material S is extruded from the secondary transfer nip of the secondary transfer unit 60. Particularly, at this time, since the air from the opening portion 402 of the housing 401 generated in involvement with an operation of an airflow generator 405 of the blowing unit 400 is sprayed in the direction indicated by the arrow D, when the rear end portion Se of the transfer material S is extruded from the secondary transfer nip, the rear end portion Se of the transfer material S contacts with the intermediate transfer belt 40, so that deterioration of the image may be prevented.

The transfer material S that is transported on the transporting surface P of the transfer material transport unit 230 is suctioned and transported by a suction force C from a suction surface 272 of a housing 271 generated in involvement with an operation of an airflow generator 275 of the second suction unit 270. After that, the transfer material S is inserted through the fixing nip formed by the heating roller 91 and the pressing roller 92 in the fixing unit 90. The toner image is fused on the transfer material S that passes through the fixing nip, so that a visible image is formed.

Next, the secondary transfer roller is described in detail.

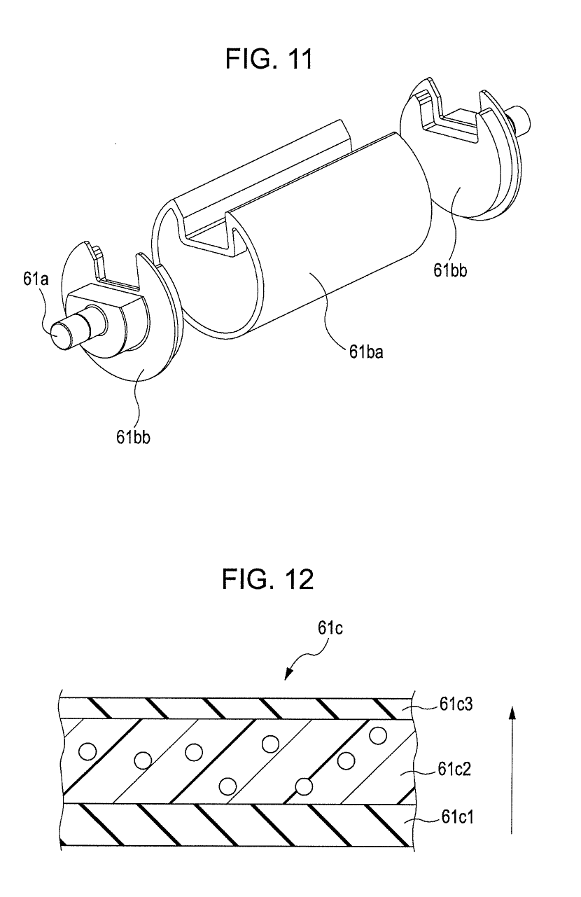

FIG. 11 is a view illustrating a rotational axis 61a and a substrate 61b of the secondary transfer roller 61 according to Example 1.

The rotational axis 61a and the substrate 61b of the secondary transfer roller 61 are made of a conductive metallic material. As shown in FIG. 11, the secondary transfer roller 61 according to Example 1 includes a generally cylindrical base portion 61ba where the substrate 61b has a recessed portion, and flange portions 61bb that are provided to the two ends of the base portion 61ba. The flange portions 61bb and the rotational axis 61a are integrally formed.

Next, the rubber sheet 61c as an elastic member that is wound around the secondary transfer roller 61 is described with reference to Examples.

Herein, volume resistivities represented in the configurations of the Examples are measured by using a resistivity meter “HIRESTA UR PROBE” manufactured by Mitsubishi Chemical Corporation. With respect to a sample of a film that is cut by a length of 400 mm, three points of the sample with an equal pitch in the width direction thereof and four points in the longitudinal (circumferential) direction (twelve points in total) are applied with a voltage of 100 V, and after 10 seconds, the volume resistivities are measured. An average of the volume resistivities is obtained.

The rubber sheet 61c according to Example 1 has the following configuration:
Layer structure: single layer
Volume Resistivity: 1×10¹⁰ (Ω·cm)
Material: urethane rubber,
Thickness: 0.5 mm
Conductive material: ion conductive material
Surface hardness of sheet material: JISA 90°

In addition, the intermediate transfer belt 40 according to Example 1 has the following configuration:
Layer structure: single-layered belt
Material: polyimide resin
Thickness: 100 μm
Conductive material: electronic conductive material (carbon)

The rubber sheet 61c and the intermediate transfer belt 40 are used for the image forming apparatus according to the first embodiment, which has a configuration of a single nip, the secondary transfer property for a coat paper is good.

Next, Example 2 is described.

The rubber sheet 61c according to Example 2 has a two-layered structure and the following configuration:
Layer structure: two layers (Young's modulus 2 GPa)
Volume resistivity: 1×10⁷ (Ω·cm)
   Substrate layer
      Material: polyimide
      Thickness: 90 μm
      Conductive material: electronic conductive material (carbon)
   Elastic layer
      Material: urethane rubber
      Thickness: 3.0 mm
      Conductive material: electronic conductive material (carbon)
Surface hardness of sheet material: JISA 35°

In addition, the Young's modulus of the rubber sheet 61c may be in a range of 2 to 5 GPa. In addition, the conductive material of the rubber sheet 61c may be an ion conductive material or a hybrid conductive material containing an electronic conductive material (carbon) and an ion conductive material. In addition, the rubber hardness may be in a range of 30° to 70°.

In addition, the intermediate transfer belt 40 according to Example 2 has the following configuration:
Layer structure: three-layered belt
   Substrate layer
      Material: polyimide resin
      Thickness: 100 μm
      Conductive material: electronic conductive material (carbon)
   Elastic layer
      Material: urethane rubber
      Thickness: 250 μm
      Conductive material: electronic conductive material (carbon)
   Superficial layer
      Material: fluorine rubber added with a fluorine resin
      Thickness: 25 μm

The rubber sheet 61c and the intermediate transfer belt 40 are used for the image forming apparatus according to the first embodiment, which has a configuration of a single nip, missed transfer to a J-paper manufactured by Fuji Xerox corporation is reduced, so that the transfer property may be improved.

Next, Examples 3 to 7 are described. FIG. 12 is a view illustrating a three-layered rubber sheet as an elastic member of the secondary transfer roller. As shown in FIG. 12, the rubber sheet 61c which is wound around the secondary transfer roller 61 according to Examples 3 to 7 has a three-layered structure of a substrate layer 61c1 as a first layer, an elastic layer 61c2 as a second layer, and a superficial layer 61c3 as a third layer. In addition, in the figure, the arrow indicates the direction from the center of the secondary transfer roller 61 to the outer circumference.

In addition, the intermediate transfer belts 40 according to Examples 3 to 7 have the following configuration:
Layer structure: three-layered belt
   Substrate layer
      Material: polyimide resin
      Thickness: 90 μm
      Conductive material: electronic conductive material (carbon)
   Elastic layer
      Material: urethane rubber
      Thickness: 150 μm
      Conductive material: electronic conductive material (carbon)
   Superficial layer
      Material: fluorine rubber added with a fluorine resin
      Thickness: 5 μm

In addition, in Examples 3 to 6, the rubber sheet 61c and the intermediate transfer belt 40 are used for the image forming apparatus according to the first embodiment, which has a configuration of a single nip; and in Example 7, the rubber sheet 61c and the intermediate transfer belt 40 are used for the image forming apparatus according to the second embodiment, which has a configuration of a winding nip.

The rubber sheets 61c according to Examples 3 to 7 are described. The configurations of the rubber sheets 61c according to Examples 3 to 7 are listed in Table 1.

TABLE 1

| | | | Superficial Layer: | Physical Properties |
|---|---|---|---|---|
| | | | Fluorine Rubber | Of Rubber Sheet |
| | Substrate Layer: | Elastic Layer: | Including Fluorine | Volume Resistivity |
| Example | Polyimide | Urethane Rubber | Resin | Surface Hardness |
| 3 | Conductive | Conductive | Conductive | 6 × 10¹⁰ Ω · cm |
| | Material: No | Material: Electronic | Material: No | 40° |
| | Thickness: 50 μm | Conduction | Thickness: 5 μm | |
| | | Thickness: 5.0 mm | | |
| 4 | Conductive | Conductive | Conductive | 2 × 10⁶ Ω · cm |
| | Material: Electronic | Material: Electronic | Material: Electronic | 40° |
| | Conduction + Ion | Conduction | Conduction + Ion | |
| | Conduction | Thickness: 2.5 mm | Conduction | |
| | Thickness: 90 μm | | Thickness: 5 μm | |
| 5 | Conductive | Conductive | Conductive | 8 × 10⁸ Ω · cm |
| | Material: Electronic | Material: Electronic | Material: Electronic | 40° |
| | Conduction | Conduction | Conduction | |
| | Thickness: 90 μm | Thickness: 1.5 mm | Thickness: 25 μm | |
| 6 | Conductive | Conductive | Conductive | 5 × 10⁹ Ω · cm |
| | Material: No | Material: Electronic | Material: Electronic | 50° |
| | Thickness: 50 μm | Conduction | Conduction + Ion | |
| | | Thickness: 0.5 mm | Conduction | |
| | | | Thickness: 25 μM | |
| 7 | Conductive | Conductive | Conductive | 6 × 10⁸ Ω · cm |
| | Material: Electronic | Material: Electronic | Material: No | 65° |
| | Conduction | Conduction | Thickness: 5 μm | |
| | Thickness: 90 μm | Thickness: 2.0 mm | | |

As listed in Table 1, in the rubber sheet 61c of Example 3, since a superficial layer 61c3 is formed, the friction coefficients of the secondary transfer roller 61 and the intermediate transfer belt 40 may be reduced, so that the deformation of the two elastic layers may be reduced.

According to the configuration listed in Table 1, in the rubber sheet 61c of Example 4, a secondary transfer efficiency of 90% or more may be obtained.

As listed in Table 1, in the rubber sheet 61c of Example 5, since all the conductive materials are electronic conductive materials, an environmental change in the volume resistivity may be reduced by one digit in a range of environmental temperature of 10 to 35° C., and due to the addition of the electronic conductive materials, small deformation may be reduced.

As listed in Table 1, in the rubber sheet 61c of Example 6, since a resistance value of the superficial layer is decreased, a detachability of paper may be improved.

The rubber sheet 61c of Example 7 is used for a winding type transfer configuration according to the second embodiment. In addition, a rubber hardness of the rubber sheet 61c is 65°, a traceability of a printing paper to uneven portions may be improved, so that missing transfer may be further solved. In addition, since the nip is configured as a winding nip, the secondary transfer efficiency is also improved, so that waste toner may be reduced.

In addition, in the case where the resistance of the rubber sheet 61c that is wound around the secondary transfer roller 61 is high, the deformation of the rubber sheet 61c is accumulated, so that the problem of the transfer defect does not occur. However, since the resistance is too high, the necessary electric field is not applied to the toner particles, and the transferability necessary for the secondary transfer due to the bias may not be obtained.

In addition, in the case where the resistance of the rubber sheet 61c that is wound around the secondary transfer roller 61 is low, since the resistance value of the secondary transfer roller 61 is lower than the resistance value of the transfer material S, current may be flown into a portion where the transfer material S doe not exist, and a sufficient electric field may not be applied to the toner particles in a portion where the transfer material S exists. In addition, the transferability necessary for the secondary transfer may not be obtained. In addition, there is a problem in that due to the charge injection to the toner, the toner charging is disturbed.

Therefore, it is preferable that the volume resistivity of the rubber sheet 61c according to the embodiment is set to be in a range of 1×10⁶ (Ω·cm) to 1×10¹¹ (Ω·cm).

In addition, as an example of a material of the substrate layer 61c1, there is polyimide or polyimide amide. In addition, in the case where a conductive material such as carbon is included in the substrate layer 61c1, a usage amount thereof may be in a range of about 5 to 25 wt % with respect to the substrate layer 61c1.

In addition, as an example of a material of the elastic layer 61c2, there is a urethane rubber, a silicone rubber, a fluorine rubber, a butyl rubber, or an acryl rubber. In addition, in the case where a conductive material such as carbon is included in the elastic layer 61c2, a usage amount thereof may be in a range of about 5 to 30 wt % with respect to the elastic layer 61c2.

In addition, as an example of a material of the superficial layer 61c3, there is a fluorine rubber or a fluorine resin. In addition, in the case where a conductive material such as carbon is included in the superficial layer 61c3, a usage amount thereof may be generally in a range of about 5 to 25 wt % with respect to the superficial layer 61c3.

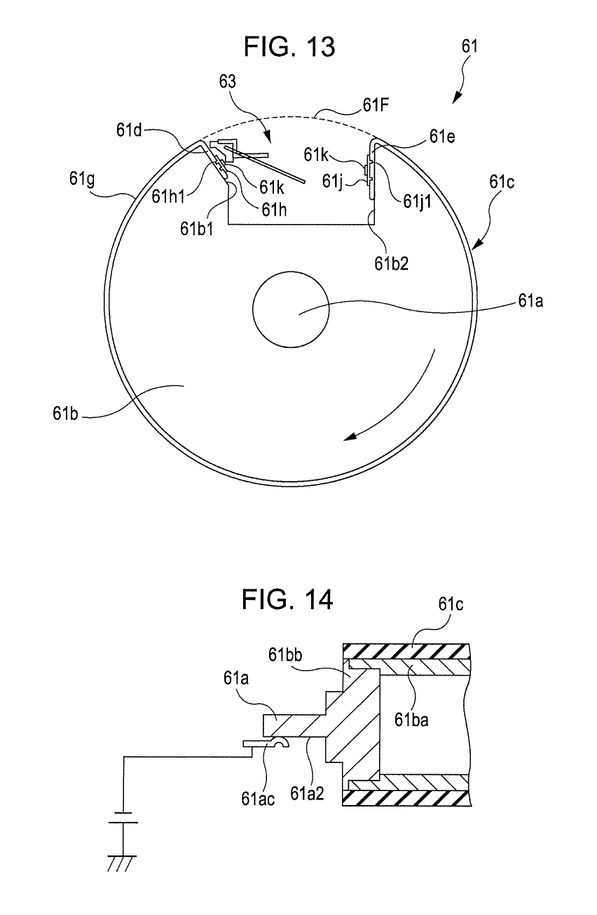

Next, a configuration of winding the secondary transfer roller 61 with a rubber sheet is described. FIG. 13 is a cross-sectional view illustrating the configuration of winding the secondary transfer roller with the rubber sheet.

The secondary transfer roller 61 has a recessed portion 63. As shown in FIG. 13, the recessed portion 63 is disposed to extend in the direction of the rotational axis 61a of the secondary transfer roller 61. In addition, the secondary transfer roller 61 has a rubber sheet 61c that is wound around the outer circumferential surface of the circular arc portion of the substrate 61b. Due to the rubber sheet 61c, a resistive layer is formed on the outer circumferential surface of the circular arc portion of the secondary transfer roller 61. The two end portions 61d and 61e of the rubber sheet 61c are configured to be fixed on the wall surfaces 61b1 and 61b2 inside the recessed portion in the substrate 61b, and other portions thereof are configured only to wind, but not to be adhered or fixed on the substrate 61b. For example, the plates 61h and 61j may be disposed on the two end portions 61d and 61e of the rubber sheet 61c to extend in the direction of the rotational axis 61a and to be fastened to the substrate 61b with screws such as screws 61k. In addition, the plates 61h and 61j are provided with protrusions 61h1 and 61j1, and the protrusions 61h1 and 61j1 are inserted into the rubber sheet 61c, so that the plates 61h and 61j are strongly fixed. In addition, the fixing of the two end portions 61d and 61e of the rubber sheet 61c to the recessed portion 63 is not limited thereto, but other methods may be used.

FIG. 14 is a view illustrating a structure of applying a bias to the rotational axis 61a and the substrate 61b of the secondary transfer roller 61. The rotational axis 61a and the substrate 61b of the secondary transfer roller 61 are applied with the bias by a bias applying unit. In the embodiment, the bias is subjected to constant-current control, so that the current at the time of transfer is set to, for example, 200 μA. As shown in FIG. 14, in the configuration of the rotational axis 61a and the substrate 61b of the secondary transfer roller 61 shown in FIG. 11, the contacting point 61ac in the Example is configured so as to abut on the circumferential portion 61a2 of the rotational axis 61a.

In addition, the applying of the bias is not limited to that shown in FIG. 14, but the bias may be applied to a portion between the secondary transfer roller 61 and the belt driving roller 41 as shown in FIG. 1 or 2.

Next, a relationship between the opening width w of the recessed portion 63 of the secondary transfer roller 61 and the nip width N of the nip portion of the belt driving roller 41 and the secondary transfer roller 61 is described.

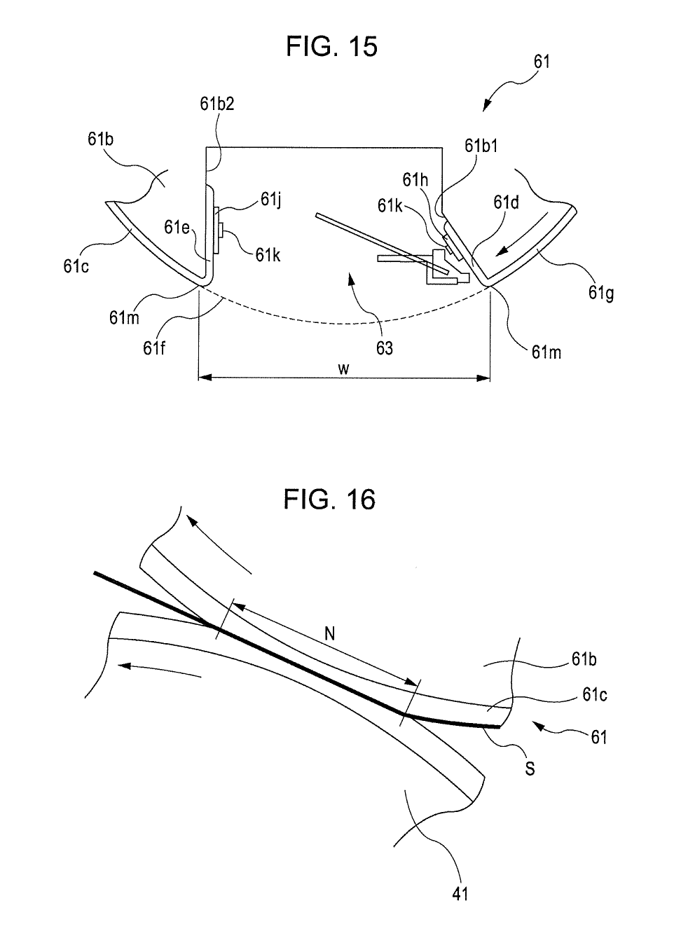

FIG. 15 is a view illustrating the opening width w of the recessed portion 63 of the secondary transfer roller 61. In the embodiment, as shown in FIG. 15, the opening width w of the recessed portion 63 of the secondary transfer roller 61, which rotates clockwise as viewed toward the paper surface of FIG. 15, is defined to a length of a straight line connecting end points 61m that are intersections between the outer line 61f of the cross section of the secondary transfer roller 61 and the outer circumferential surface 61g of the rubber sheet 61c. In the embodiment, the opening width w is set to 100 mm.

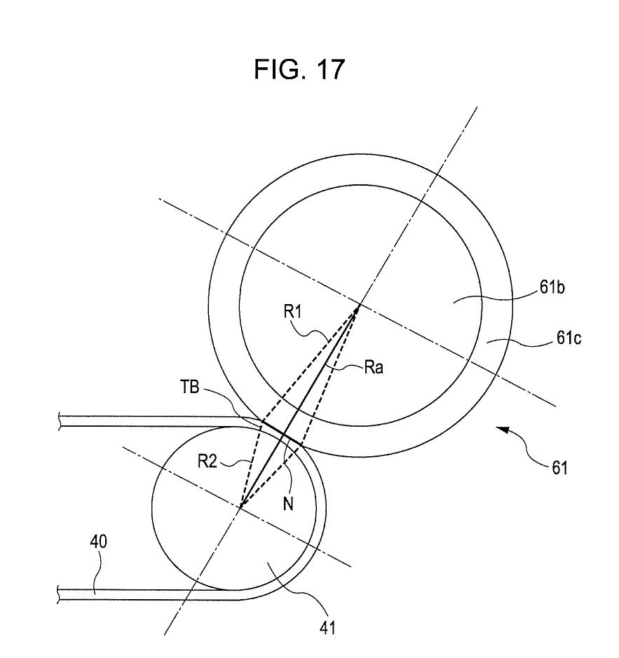

FIG. 16 is a view illustrating a nip width N between the belt driving roller 41 and the secondary transfer roller 61 according to the first embodiment. FIG. 17 is a schematic view for explaining calculation of the nip width N between the secondary transfer roller 61 and the transfer drum 41 according to the first embodiment.

R1 denotes a radius of the secondary transfer roller 61; R2 denotes a radius of the transfer drum 41; TB denotes a thickness of the intermediate transfer belt 40; and Ra denotes an inter-axis distance between the two rollers. An area S of a triangle constructed with R1, (R2+TB), and Ra is obtained by using Heron's formula, as follows.

S=√(s(s−R1)(s−(R2+TB))(s−Ra) (1)

Herein, s=(R1+(R2+TB)+Ra)/2. When a bottom side of the triangle constructed with three sides R1, (R2+TB), and Ra is set to Ra, the height of the triangle is N/2. Therefore, the area S of the triangle is obtained as follows.

S=Ra×(N/2)/2=RaN/4 (2)

From the Formulas (1) and (2), the following formula can be obtained.

N=(√(s(s−R1)(s−(R2+TB))(s−Ra)))×4/Ra

Herein, s=(R1+(R2+TB)+Ra)/2.

In the first embodiment, the diameter of the secondary transfer roller 61 is set to 190 mm, and the diameter of the belt driving roller 41 is set to 70 mm. In this case, the nip width N is 5 mm.

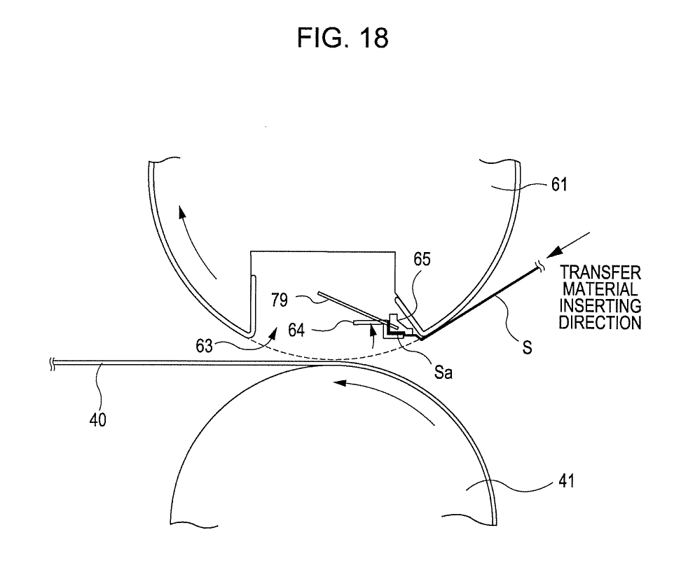

FIG. 18 is a view illustrating a state where the belt driving roller 41 is located at a position corresponding to the recessed portion 63 of the secondary transfer roller 61.

As shown in FIG. 18, an opening width w of the recessed portion 63 of the secondary transfer roller 61 is configured to be larger than the nip width N of the nip portion between the belt driving roller 41 and the secondary transfer roller 61, so that a state where the secondary transfer roller 61 has no nip portion is temporarily formed. Therefore, the stress to the rubber sheet 61c is released, so that the accumulation of deformation may be suppressed. In addition, a state the belt driving roller 41 also has no nip portion is formed. Therefore, the stress to the intermediate transfer belt 40 is released, so that the accumulation of deformation may be suppressed. In addition, the secondary transfer roller 61 may not be separated from the nip portion between the secondary transfer roller 61 and the belt driving roller 41, and the rotation of the intermediate transfer belt 40 is stabilized, so that a good image is formed.

In addition, as shown in FIG. 18, it is preferable that the image forming apparatus has a stopping process of stopping the image forming apparatus by locating the recessed portion 63 of the secondary transfer roller 61 to the transferring nip portion between the belt driving roller 41 and the secondary transfer roller 61. Even in the state where the image forming apparatus is stopped for a long time, since the belt driving roller 41 and the secondary transfer roller 61 do not push against each other (i.e., a prescribed gap is formed between the belt driving roller 41 and the secondary transfer roller 61), it is possible to suppress occurrence of deformation during the stopped interval.

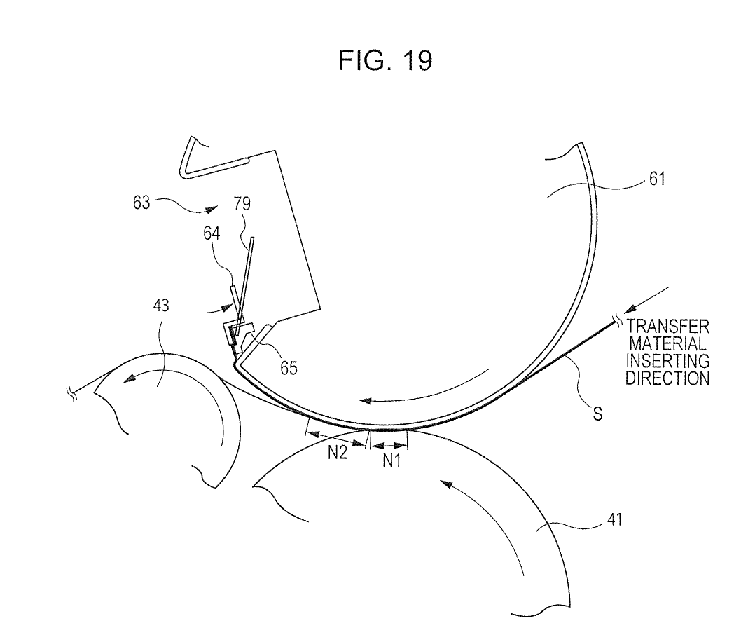

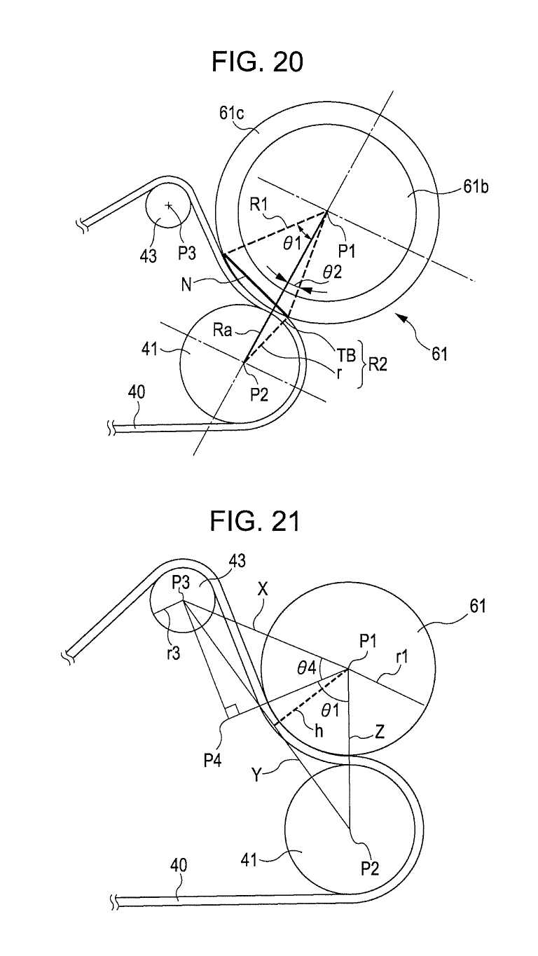

FIG. 19 is a view illustrating the nip width N of the winding nip portion between the belt driving roller 41 and the secondary transfer roller 61 according to the second embodiment. FIG. 20 is a schematic view for explaining calculation of the nip width N between the secondary transfer roller 61 and the transfer drum 41 according to the second embodiment. FIG. 21 is a schematic view for obtaining an angle θ1 used for the calculation.

An angle between a line connecting the central axes of the belt driving roller 41 and the secondary transfer roller 61 and a line connecting the position where the intermediate transfer belt 40 is separated from the secondary transfer roller 61 and the central axis of the secondary transfer roller 61 is set to θ1.

If the nip width between the belt driving roller 41 and the secondary transfer roller 61 calculated based on the aforementioned formulas for calculation of the nip width is denoted by N2, θ2 is obtained by using the following formula.

θ2=sin−1((N2/2)/R1))

In the case where θ=θ1+θ2, the nip width N in the winding type configuration is calculated by using the following formula.

N=2×R1×sin(θ/2)

Herein, θ1 is obtained with reference to FIG. 21. The inter-axis distances of the three rollers are set to P1−P3=X, P3−P2=Y, and P2−P1=Z, respectively. An area S and height h of a triangle constructed with three sides X, Y, and Z are obtained by using Heron's formula, as follows.

S=√(s(s−X)(s−Y)(s−Z))

Herein, s=(X+Y+Z)/2.

h=2S/Y

Herein, the angle (∠P1) formed by P3−P1−P2 may be expressed by the following relationship.

∠P1=180−sin⁻¹(h/X)−sin⁻¹(h/Z).

In the case where the point at which the line passing through P3 as a perpendicular line intersects the straight line passing through P1 and the position, where the intermediate transfer belt 40 starts to be separated from the secondary transfer roller 61, is set to P4, if the radius of the secondary transfer roller 61, the radius of the second tension roller 43, and the thickness of the intermediate transfer belt 40 are denoted by r1, r3, and TB, the distance of P1−P4 becomes r3+r1+TB. Since the distance of P1−P3 is X, angle θ4 formed by P3−P1−P4 may be expressed as follows.

θ4=cos⁻¹((r3+r1+TB)/X)

Therefore, the angle θ1 where the secondary transfer roller 61 is wound with the belt may be expressed as follows.

θ1=∠P1(=180−sin⁻¹(h/X)−sin⁻¹(h/Z))−θ4(=cos⁻¹(r3+r1+TB)/X))

Next, by substituting the angles θ1 and θ2 into the Formula 2, the nip width N is obtained.

In the second embodiment, the diameter of the secondary transfer roller 61 is set to 190 mm, and the diameter of the belt driving roller 41 is set to 70 mm. In this case, the nip width N1 of the nip portion between the belt driving roller 41 and the secondary transfer roller 61 is 5 mm. In the case where the nip width N2 of the nip portion of the winding portion of the intermediate transfer belt 40 is set to 15 mm, the nip width N1 is about 20 mm.

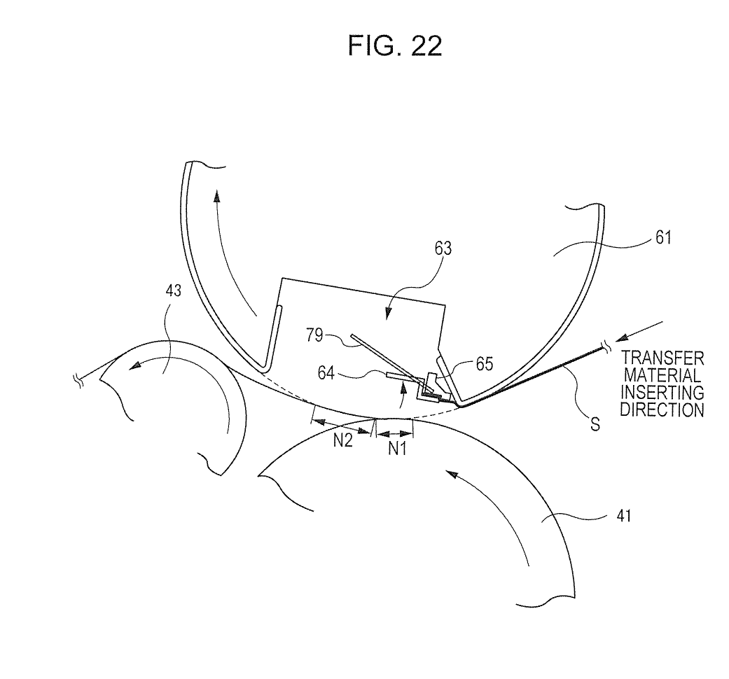

FIG. 22 is a view illustrating a state where the belt driving roller 41 and a portion of the winding portion is located at a position corresponding to the recessed portion 63 of the secondary transfer roller 61.

The opening width w of the recessed portion 63 of the secondary transfer roller 61 is configured to be larger than the nip width N that is obtained by using the aforementioned formula based on the nip portion N1 between the belt driving roller 41 and the secondary transfer roller 61 and the nip portion N2 of the winding portion of the intermediate transfer belt 40, so that a state where the secondary transfer roller 61 has no nip portion is temporarily formed. Therefore, the stress of the rubber sheet 61c is released, so that the accumulation of deformation may be suppressed. In addition, a state where the belt driving roller 41 also has no nip portion is formed. Therefore, the stress of the intermediate transfer belt 40 is released, so that the accumulation of deformation may be suppressed. In addition, the secondary transfer roller 61 may not be separated from the nip portion between the secondary transfer roller 61 and the belt driving roller 41, and the rotation of the intermediate transfer belt 40 is stabilized, so that a good image is formed.

In addition, as shown in FIG. 22, it is preferable that the image forming apparatus has a stopping process of stopping the image forming apparatus by locating the recessed portion 63 of the secondary transfer roller 61 to the transferring nip portion between the belt driving roller 41 and the secondary transfer roller 61. Even in the state where the image forming apparatus is stopped for a long time, since the belt driving roller 41 and the secondary transfer roller 61 do not push against each other (i.e., a prescribed gap is formed between the belt driving roller 41 and the secondary transfer roller 61), it is possible to suppress occurrence of deformation during the stopped interval.

In the secondary transfer roller 61 according to the embodiments, as shown in FIG. 13, the two end portions 61d and 61e of the rubber sheet 61c are configured to be fixed on the wall surfaces 61b1 and 61b2 inside the recessed portion formed in the substrate 61b, and other portions thereof are configured only to wind, but not to be adhered or fixed. Therefore, during the time that the secondary transfer roller 61 has a nip portion with respect to the belt driving roller 41, the stress of the rubber sheet 61c is accumulated due to the nip pressure, so that deformation may occur. In addition, since the rubber sheet 61c has a multi-layered structure, the deformation may more easily occur due to a difference in hardness between the layers. In addition, since the secondary transfer roller 61 applies the bias under constant-current control, resistance adjustment may be performed. Therefore, since the rubber sheet 61c contains resistance adjusting particles such as carbon, deformation unevenness may easily occur due to existence of the solid state particles. The deformation unevenness of the rubber sheet 61c leads to transfer defect, so that image quality may deteriorate.

Therefore, in the secondary transfer roller 61 according to the embodiments, the volume resistivity of the rubber sheet 61c is set to be in a range of 1×10⁶ (Ω·cm) to 1×10¹¹ (Q·cm), and the opening width w of the recessed portion 63 of the secondary transfer roller 61 shown in FIG. 15 is set to be larger than the nip width N of the nip portion between the belt driving roller 41 and the secondary transfer roller 61 shown in FIG. 16 and the nip widths N of the nip portion and the winding nip portion between the belt driving roller 41 and the secondary transfer roller 61 shown in FIG. 19, that is, w>N.

However, as shown in FIGS. 18 and 22, when the belt driving roller 41 and the recessed portion 63 are in the state of facing each other, the secondary transfer roller 61 is necessarily positioned relative to the belt driving roller 41 at a high accuracy.

Therefore, as shown in FIG. 1 or 2, it is preferable that the secondary transfer roller 61 is forced by a spring (not shown) to pressingly abut on the belt driving roller 41, and the abutting members 70 and 71 shown in FIG. 3 are formed. Herein, the abutting member 70 is described. In addition, herein although only the abutting member 70 is described, the abutting member 71 also has the same configuration.

The abutting member 70 has an outer circumferential surface 70a having a circular arc shape that is concentric with the circle of the outer line 61f of the secondary transfer roller 61 shown in FIG. 13, so that the abutting member 70 is integrally rotated with the secondary transfer roller 61. According to the configuration, when the belt driving roller 41 is moved from the abutting position for the secondary transfer roller 61 to the abutting position for the abutting member 70, and when the belt driving roller 41 is moved from the abutting position for the abutting member 70 to the abutting position for the secondary transfer roller 61, a change in load may be reduced.

Next, a relationship among the secondary transfer roller 61, the intermediate transfer belt 40, and the abutting member 70 is described.

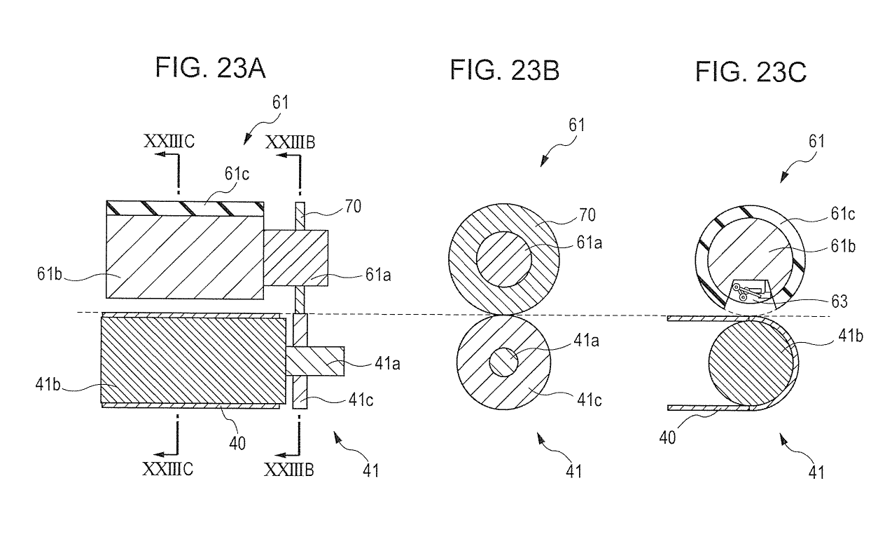

FIGS. 23A to 23C are views illustrating a relationship among the secondary transfer roller 61, the belt driving roller 41, the intermediate transfer belt 40, and the abutting member 70. FIG. 23A is an axial cross-sectional view illustrating the relationship among the secondary transfer roller 61, the belt driving roller 41, the intermediate transfer belt 40, and the abutting member 70. FIG. 23B is a cross-sectional view taken along line XXIIIB-XXIIIB of FIG. 23A, and FIG. 23C is a cross-sectional view taken along line XXIIIC-XXIIIC of FIG. 23A. As shown in FIG. 23A, the belt driving roller 41 has an abutting member supporting portion 41c. As shown in FIG. 23B, the abutting member supporting portion 41c is integrally formed in the belt driving roller 41, and the diameter thereof is a sum of twice the thickness of the intermediate transfer belt 40 and the diameter of the belt driving roller 41. As shown in FIG. 23B, the abutting members 70 and 71 abut on the abutting member supporting portion 41c. According to the configuration, the accuracy of positioning of the abutting member supporting portion 41c of the belt driving roller 41 may be improved.

Next, the secondary transfer roller 61 and the intermediate transfer belt 40 are described.

In the case where the intermediate transfer belt 40 has an elastic layer in a seamless structure, the deformation may be more effectively reduced. In addition, it is preferable that the intermediate transfer belt 40 has a superficial layer, of which the friction coefficient is small. If the friction coefficient of the superficial layer is configured to be small, a slidability of the superficial layer is improved, so that the deformation of the rubber sheet 61c of the secondary transfer roller 61 and the intermediate transfer belt 40 may be reduced. In addition, the tack property of the substrate layer is preferably small, more preferably smaller than that of the elastic layer. If the tack property of the substrate layer is configured to be small, the deformation of the side of the substrate layer is reduced, so that stable driving may be performed.

In addition, the rotating period (e.g., an amount of time required to complete one cycle of rotation) of the secondary transfer roller 61 and the moving period (e.g., an amount of time required to complete one cycle of the belt movement) of the intermediate transfer belt 40 are set to have a non-integer multiple relationship, so that the relaxation in pressure at the same position of the transfer medium is prevented and so that the accumulation of deformation at the same position is prevented. In addition, since the rotating period of the rubber sheet 61c is smaller than the moving period of the intermediate transfer belt 40 or the intermediate transfer drums 46 and 48 (third embodiment), the deformation in the rotation axial direction of the intermediate transfer belt 40 or the intermediate transfer drums 46 and 48 may be removed.

In addition, it is preferable that, in the axial direction of the secondary transfer roller 61, the width of the intermediate transfer belt 40 is larger than the width of the rubber sheet 61c. According to the configuration, the deformation in the width direction of the intermediate transfer belt 40 (in the axial direction of the secondary transfer roller 61) may be removed. In addition, it is preferable that the driving unit of the secondary transfer roller 61 and the driving unit of the intermediate transfer belt 40 are provided to the same side in the axial direction of the secondary transfer roller 61. According to the configuration where the driving units are provided to the same side, since the rubber sheet 61c of the secondary transfer roller 61 and the intermediate transfer belt 40 are deformed in the same side, interference between the rubber sheet 61c and the intermediate transfer belt 40 may be reduced.

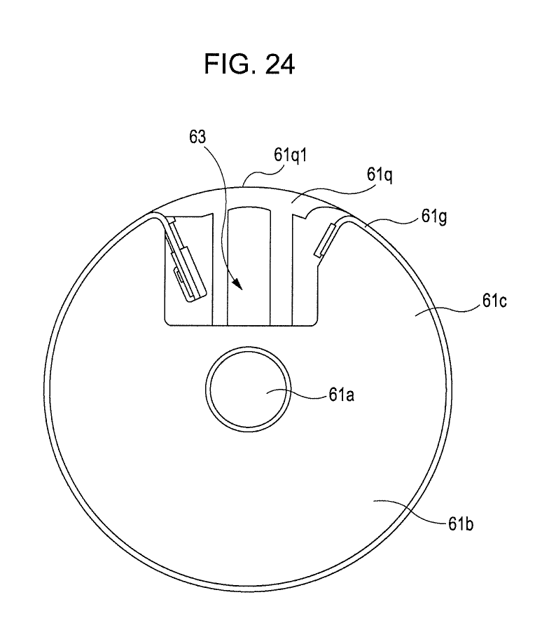

FIG. 24 is a view illustrating a modified example of the abutting member. In the modified example, the abutting member 61q having an outer circumferential surface 61q1 having the same diameter as that of the outer circumferential surface 61g of the secondary transfer roller 61 is provided inside the recessed portion 63. According to the configuration, as shown in FIG. 2, in the case where the secondary transfer roller 61 wound with the intermediate transfer belt 40 is used, the winding shape is changed by the recessed portion 63 of the secondary transfer roller 61, so that unstable driving of the intermediate transfer belt 40 may be reduced. In addition, when the abutting member 61q is provided inside the recessed portion 63, the abutting member 61q is not provided to a claw driving portion or a paper inserting portion.

Next, a transfer apparatus and an image forming apparatus according to a third embodiment are described.

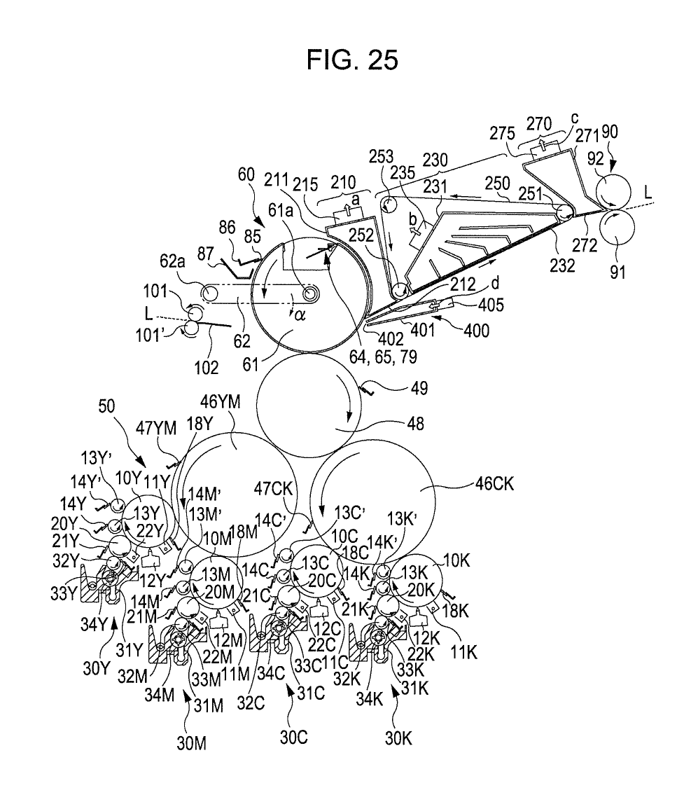

FIG. 25 is a view illustrating main components constituting an image forming apparatus according to a third embodiment. In the image forming apparatus according to the third embodiment, a first intermediate transfer drum 46YM, a second intermediate transfer drum 46CK, and a third intermediate transfer drum 48 are used as transfer medium.

Each of the first intermediate transfer drum 46YM, the second intermediate transfer drum 46CK, and the third intermediate transfer drum 48 is provided with a seamless rubber layer that is formed in a main body portion made of a conductive metal. The first intermediate transfer drum 46YM abuts on the photoreceptors 10Y and 10M, the second intermediate transfer drum 46CK abuts on the photoreceptors 10C and 10K. The toner images developed on the photoreceptors 10Y and 10M are transferred to the first intermediate transfer drum 46YM as the transferring positions set to the abutting positions with respect to the photoreceptors 10Y and 10M, so that toner images are formed. The toner images developed on the photoreceptors 10C and 10K are transferred to the second intermediate transfer drum 46YM as the transferring positions set to the abutting positions with respect to the photoreceptors 10C and 10K, so that toner images are formed. Next, the toner image on the first intermediate transfer drum 46YM is transferred to the third intermediate transfer drum 48 as the transferring position set to the abutting position with respect to the first intermediate transfer drum 46YM. The toner image on the second intermediate transfer drum 46CK is transferred to the third intermediate transfer drum 48 as the transferring position set to the abutting position with respect to the second intermediate transfer drum 46CK. The toner image contained in the third intermediate transfer drum 48 is transferred to the transported transfer material S by the transfer unit 60. The transfer unit 60 includes a transfer roller 61 as a transfer member. The transfer roller 61 is the same as the secondary transfer rollers used in the first and second embodiments. Thus, the above explained configurations the rubber sheet 61c according to Examples 1 to 7 are also applicable to the transfer roller 61 of the third embodiment.

In addition, a first intermediate transfer drum cleaning blade 47YM that cleans the first intermediate transfer drum 46YM abuts on the first intermediate transfer drum 46YM. The abutting position of the first intermediate transfer drum cleaning blade 47YM is located after the abutment on the third intermediate transfer drum 48 and before the abutment on the photoreceptors 10Y and 10M. Similarly, a second intermediate transfer drum cleaning blade 47CK that cleans the second intermediate transfer drum 46CK abuts on the second intermediate transfer drum 46CK. The abutting position of the second intermediate transfer drum cleaning blade 47CK is located after the abutment on the third intermediate transfer drum 48 and before the abutment on the photoreceptors 10C and 10K. In addition, a third intermediate transfer drum cleaning blade 49 that cleans the third intermediate transfer drum 48 abuts on the third intermediate transfer drum 48. The abutting position of the third intermediate transfer drum cleaning blade 49 is located after the abutment on the transfer roller 61 and before the abutment on the first intermediate transfer drum 46YM and the second intermediate transfer drum 46CK.

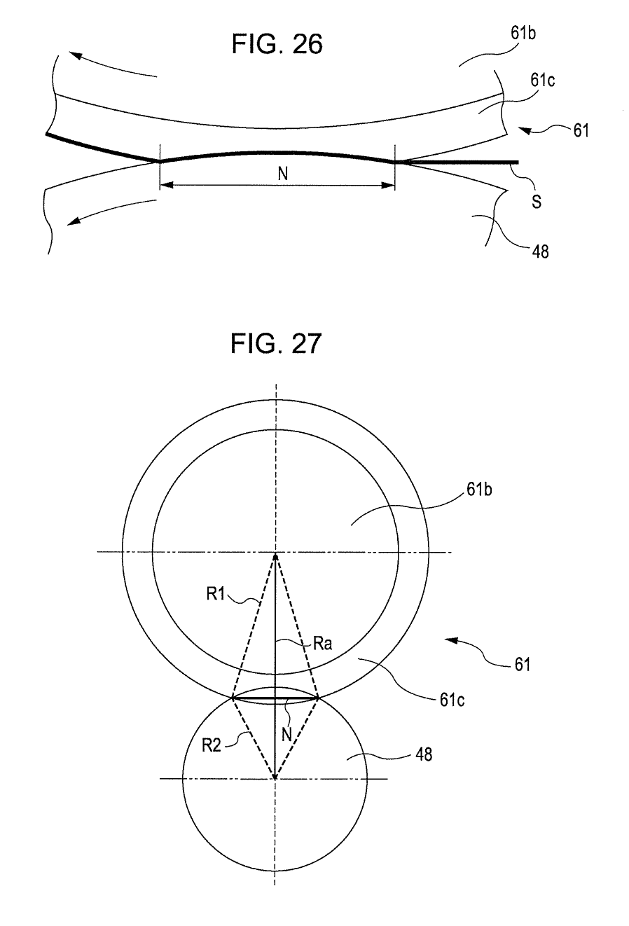

FIG. 26 is a view illustrating the nip width N of the nip portion between the third intermediate transfer drum 48 and the transfer roller 61 according to the third embodiment. FIG. 27 is a schematic view for explaining calculation of the nip width N of the transfer roller 61 and the third intermediate transfer drum 48 according to the third embodiment.

R1 denotes a radius of the transfer roller 61; R2 denotes a radius of the third intermediate transfer drum 48; and Ra denotes an inter-axis distance between the transfer roller 61 and the third intermediate transfer drum 48. An area S of a triangle constructed with R1, R2, and Ra is obtained by using Heron's formula, as follows.

S=√(s(s−R1)(s−R2)(s−Ra))

Herein, s=(R1+R2+Ra)/2.

When a bottom side of the triangle constructed with three sides R1, R2, and Ra is set to Ra, the height of the triangle is N/2. Therefore, the area S of the triangle is obtained as follows.

S=Ra×(N/2)/2=RaN/4

From the above formulas, the following relationship can be obtained.

N=(√(s(s−R1)(s−R2)(s−Ra)))×4/Ra.

Herein, s=(R1+R2+Ra)/2.

In the embodiment, the diameter of the transfer roller 61 is set to 190 mm, and the diameter of the third intermediate transfer drum 48 is set to 190 mm. In this case, the nip width N is 10 mm.

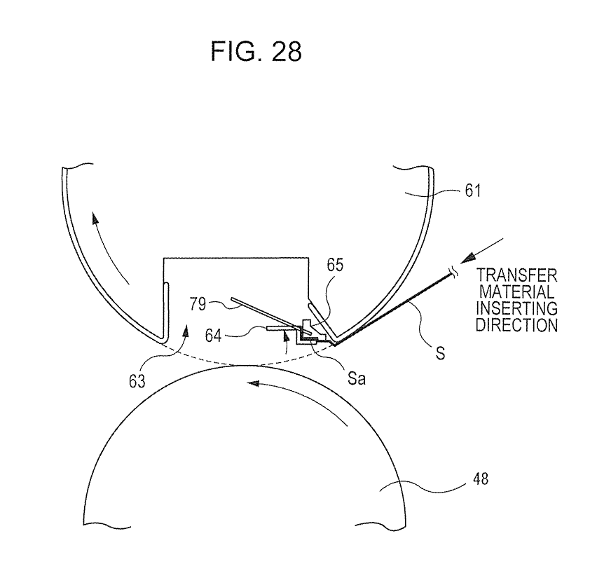

FIG. 28 is a view illustrating a state where the third intermediate transfer drum 48 is located at a position corresponding to the recessed portion 63 of the transfer roller 61. As shown in FIG. 28, an opening width w of the recessed portion 63 of the transfer roller 61 is configured to be larger than the nip width N of the nip portion between the third intermediate transfer drum 48 and the transfer roller 61, so that a state where the third intermediate transfer drum 48 and the transfer roller 61 have no nip portion is temporarily formed. Therefore, the stress of the rubber sheet 61c is released, so that the accumulation of deformation may be suppressed. In addition, the transfer roller 61 may not be separated from the nip portion between the transfer roller 61 and the third intermediate transfer drum 48, and the rotation of the third intermediate transfer drum 48 is stabilized, so that a good image is formed.

In addition, as shown in FIG. 28, it is preferable that the image forming apparatus has a stopping process of stopping the image forming apparatus by locating the recessed portion 63 of the transfer roller 61 to the transferring nip portion between the third intermediate transfer drum 48 and the transfer roller 61. Even in the state where the image forming apparatus is stopped for a long time, since the third intermediate transfer drum 48 and the transfer roller 61 do not push against each other (i.e., a prescribed gap is formed between the third intermediate transfer drum 48 and the transfer roller 61), it is possible to suppress occurrence of deformation during the stopped interval.

In addition, the image forming apparatus may has a structure where direct transfer from the photoreceptors 10Y, 10M, 10C, and 10K as the image bearing parts s to the transfer roller 61 is performed.

In the transfer apparatus and the image forming apparatus according to the embodiment, since the secondary transfer roller 61 may be formed in the state of having no nip portion with respect to the rubber sheet 61c that is fixed in the recessed portion and wound around the outer circumference of the substrate 61b, the deformation of the rubber sheet 61c of the secondary transfer roller 61 and the transfer defect involved with the deformation are reduced. Accordingly, it is possible to provide a transfer apparatus for excellently performing transfer and an image forming apparatus for excellently forming an image.

In addition, in the case where resistance adjusting particles of adjusting a transfer bias so as to excellently perform transfer are contained in the rubber sheet 61c, in general, small deformation unevenness may easily occur. However, in the transfer apparatus and the image forming apparatus according to the embodiment, since a state where the nip portion with respect to the rubber sheet 61c is not be formed may be formed, the small deformation unevenness in the rubber sheet 61c caused by the resistance adjusting particles may be reduced.

In addition, in the case where the rubber sheet 61c includes the substrate layer 61c1 and the elastic layer 61c2, the nip width or the tension may be adjusted by adjusting the degree of elasticity or the thickness, but the deformation may easily occur. However, in the transfer apparatus and the image forming apparatus according to the embodiment, since a state where the nip portion with respect to the rubber sheet 61c is not be formed may be formed, the deformation occurring in the elastic member may be reduced. In addition, since the rubber sheet 61c includes the superficial layer 61c3 having a friction coefficient that is smaller than that of the elastic layer 61c2, the frictional resistance may be reduced, so that the deformation occurring in the rubber sheet 61c may be reduced.

In addition, since the intermediate transfer belt 40 or the intermediate transfer drums 46 and 48 have an elastic layer, when the recessed portion 63 of the secondary transfer roller 61 or the transfer roller 61 is positioned at the nip portion with respect to the secondary transfer roller 61 or the transfer roller 61, no nip portion may be configured to be formed. In this configuration, the deformation of the elastic layer of the intermediate transfer belt 40 or the intermediate transfer drums 46 and 48 and the transfer defect involved with the deformation are reduced. Accordingly, it is possible to provide a transfer apparatus for excellently performing transfer and an image forming apparatus for excellently forming an image.

In addition, the rotating period of the secondary transfer roller 61 or the transfer roller 61 and the moving period of the intermediate transfer belt 40 or the intermediate transfer drums 46 and 48 are set to have a non-integer multiple relationship, so that the relaxation in pressure at the same position of the transfer medium is prevented and so that the accumulation of deformation at the same position is prevented.

In addition, since the rotating period of the rubber sheet 61c is smaller than the moving period of the intermediate transfer belt 40 or the intermediate transfer drums 46 and 48, the deformation in the rotation axial direction of the intermediate transfer belt 40 or the intermediate transfer drums 46 and 48 may be removed.

In addition, since the secondary transfer roller 61 or the transfer roller 61 has the gripper 64 that grips the transfer material, a variation in position of the transfer material with respect to the secondary transfer roller 61 or the transfer roller 61 may be reduced.

In addition, since the secondary transfer roller 61 or the transfer roller 61 has the extruding claw 79 that detaches the transfer material, the detachment of the transfer material from the secondary transfer roller 61 or the transfer roller 61 may be excellently performed.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A transfer apparatus comprising:
an image bearing unit configured and arranged to bear an image;
a transfer member arranged with respect to the image bearing unit to form a nip portion therebetween, the transfer member including
a substrate having a recessed portion with an opening width of the recessed portion being larger than a width of the nip portion as measured in a moving direction of the transfer member, and
an elastic member fixed in the recessed portion and wound around the substrate, the elastic member having a volume resistivity of 1×10⁶ to 1×10¹¹ Ω·cm; and
a bias generator configured and arranged to apply a bias electric field to the nip portion.

2. The transfer apparatus according to claim 1, wherein
the elastic member contains resistance adjusting particles.

3. The transfer apparatus according to claim 1, wherein
the elastic member includes a first layer disposed on the substrate and a second layer disposed on the first layer with the second layer having elasticity.

4. The transfer apparatus according to claim 3, wherein
the elastic member includes a third layer disposed on the second layer with the third layer having a friction coefficient that is smaller than that of the second layer.

5. An image forming apparatus comprising:
a latent image bearing part configured and arranged to bear a latent image;
a developing unit configured and arranged to develop the latent image on the latent image bearing part by using a liquid developing agent;
a transfer medium to which a developed image on the latent image bearing part is transferred;
a transfer member arranged with respect to the transfer medium to form a nip portion therebetween, the transfer member including
a substrate having a recessed portion with an opening width of the recessed portion being larger than a width of the nip portion as measured in a moving direction of the transfer medium, and
an elastic member fixed in the recessed portion and wound around the substrate with the elastic member having a volume resistivity of 1×10⁶ to 1×10¹¹ Ω·cm; and
a bias generator configured and arranged to apply a bias electric field to the nip portion.

6. The image forming apparatus according to claim 5, wherein
the elastic member includes a first layer disposed on the substrate and a second layer disposed on the first layer with the second layer having elasticity.

7. The image forming apparatus according to claim 6, wherein
the elastic member includes a third layer disposed on the second layer with the third layer having a friction coefficient that is smaller than that of the second layer.

8. The image forming apparatus according to claim 5, wherein
the elastic member contains resistance adjusting particles.

9. The image forming apparatus according to claim 5, wherein
the transfer medium includes an elastic layer.

10. The image forming apparatus according to claim 5, wherein
the transfer member is configured and arranged to rotate such that a rotating period of the transfer member and a moving period of the transfer medium have a non-integer multiple relationship.

11. The image forming apparatus according to claim 10, wherein
the rotating period of the elastic member is shorter than the moving period of the transfer medium.

12. The image forming apparatus according to claim 5, wherein
the substrate of the transfer member includes a transfer material gripping portion disposed in the recessed portion, the transfer material gripping portion being configured and arranged to grip a transfer material.

13. The image forming apparatus according to claim 12, wherein
the substrate of the transfer member includes a transfer material detaching portion disposed in the recessed portion, the transfer material detaching portion being configured and arranged to detach the transfer material from the transfer member.

14. An image forming method for forming an image by an image forming apparatus, the image forming method comprising:
forming a latent image on a latent image bearing part;
developing the latent image by using a liquid developing agent;
transferring a developed image to a transfer medium;
transporting a transfer material to a nip portion formed between the transfer medium and a transfer member having a substrate and an elastic member with the substrate including a recessed portion with an opening width of the recessed portion being larger than a width of the nip portion as measured in a moving direction of the transfer medium;
transferring the developed image from the transfer medium to the transfer material; and
stopping the image forming apparatus in a state in which the recessed portion of the transfer member is aligned with the nip portion so that a prescribed gap is formed between the transfer medium and the transfer member.
